(19) United States
(12) Patent Application Publication
(10) Pub. No.: US 2014/0338624 A1
(43) Pub. Date: Nov. 20, 2014

(54) LIQUID FUEL COMPOSITIONS

(71) Applicant: SHELL OIL COMPANY, Houston, TX (US)

(72) Inventors: Mark Lawrence BREWER, Ince (GB); Susan Jane SMITH, Ince (GB)

(21) Appl. No.: 14/282,767

(22) Filed: Jul. 30, 2014

Related U.S. Application Data
(62) Division of application No. 13/482,773, filed on May 29, 2012, now abandoned.

(30) Foreign Application Priority Data
May 30, 2011 (EP) 11168052.6

(51) Int. Cl. C10L 1/19; F02B 47/04

(52) U.S. Cl. CPC C10L 1/19; F02B 47/04
USPC 123/1 A

(57) ABSTRACT

A liquid fuel composition is provided containing:
(a) a base fuel suitable for use in an internal combustion engine;
(b) a first fuel additive selected from one or more viscosity control agents having:
(i) a kinematic viscosity at 100° C. of 27 cSt or less; and
(ii) a NOACK volatility at 250° C. of 100% wt or less; and
(c) a second fuel additive selected from one or more friction modifiers.

Fuelling such liquid fuel composition in an internal combustion engine improves the fuel economy performance of an internal combustion engine.

The present application claims the benefit of pending European Patent Application No. 11168052.6, filed May 30, 2011 the entire disclosure of which is hereby incorporated by reference.

### FIELD OF THE INVENTION

The present invention relates to a liquid fuel composition.

### BACKGROUND OF THE INVENTION

Government regulations and market demands continue to emphasize conservation of fossil fuels in the transportation industry. There is increasing demand for more fuel-efficient vehicles in order to meet CO₂ emissions reductions targets. Therefore, any incremental improvement in fuel economy (FE) is of great importance in the automotive sector. Lubricants can play an important role in reducing a vehicle's fuel consumption and there is a continuing need for improvements in fuel economy performance of lubricant compositions contained within an internal combustion engine.

R. I. Taylor & R. C. Coy, “Improved Fuel Efficiency by Lubricant Design: A Review”, Proc Instn Mech Engrs, Vol 214, Part J, pp 1-15, 2000, reviews the properties of the lubricant composition that affect fuel consumption. In particular, this review paper teaches that one of the properties of a lubricant composition which affects the fuel economy performance of that lubricant composition is viscosity. The lower the viscosity of the lubricant composition, the greater the fuel economy performance of that lubricant composition [SAE 982502]. However, viscosity increase is often observed during an oil drain interval (ODI) [SAE 2008-01-1740], which is expected to be detrimental to fuel economy.

### SUMMARY OF THE INVENTION

Accordingly, in one embodiment provides a liquid fuel composition comprising:
(a) a base fuel suitable for use in an internal combustion engine;
(b) a first fuel additive selected from one or more viscosity control agents having:
(i) a kinematic viscosity at 100° C. of 27 cSt or less; and
(ii) a NOACK volatility at 250° C. of 100% wt, preferably 20% wt or less; and
(c) a second fuel additive selected from one or more friction modifiers.

In a further embodiment provides a method of improving the fuel economy performance of an internal combustion engine, said method comprising (a) fuelling an internal combustion engine containing an engine lubricant with such liquid fuel composition and (b) operating said fuelled-internal combustion engine.

### DETAILED DESCRIPTION OF THE INVENTION

While the lubricant formulation remains fixed from the beginning, an opportunity has been identified to influence the lubricant positively via the fuel composition, in particular by adding certain fuel additives to the fuel composition.

Viscosity control additives such as polyalphaolefins and esters are known for use in liquid fuel compositions and have been disclosed in the following patent publications: EP-A-707058; EP-A-290088; EP-A-634472; WO98/11178 and WO98/11177.

EP-A-707058 and discloses a fuel composition comprising a gasoline base fuel, a polyalphaolefin and a detergent which may be a polyisobutylenyl succinimide or an aliphatic or alkoxylated polyamine. EP-A-634472 also discloses a fuel composition comprising a gasoline base fuel, a polyalphaolefin and a succinimide. A detergent in a fuel composition aids performance by cleaning the internal parts of an engine during use and reducing engine deposits. Detergents in general, and succinimide derivatives in particular, do not contribute significantly to lubricity and reduced friction, and are not therefore known to act as friction modifiers, nor to aid fuel economy via friction reduction.

It has now been found that the use of selected viscosity control additives having certain physical properties together with selected friction modifiers in liquid fuel compositions can provide benefits in terms of improved fuel economy and improved engine lubricant performance.

The liquid fuel composition contains a base fuel suitable for use in an internal combustion engine, a first fuel additive selected from viscosity control agents having certain physical properties and a second fuel additive which is a friction modifier. Typically, the base fuel suitable for use in an internal combustion engine is a gasoline or a diesel fuel, and therefore the liquid fuel composition of the present invention is typically a gasoline composition or a diesel fuel composition.

As used herein, the term “viscosity control additive” or “VCA” is a fuel-borne additive intended to control increases in lubricant viscosity. As used herein, the term “friction modifier” or “FM” is an additive intended to reduce the coefficient of friction, normally in the boundary lubrication regime.

The first fuel additive used in the liquid fuel composition herein is a viscosity control agent (VCA) and has a kinematic viscosity at 100° C. (as measured by ASTM D 445 or IP71) of 27 cSt or less. Preferably, the kinematic viscosity at 100° C. (as measured by ASTM D 445) additionally accords with one or more of the parameters listed below:

(i) 22 cSt or less;
(ii) 17 cSt or less;
(iii) 13 cSt or less;
(iv) 10 cSt or less;
(v) 8 cSt or less;
(vi) 6 cSt or less;
(vii) 5.5 .cSt or less;
(viii) At least 2 cSt;
(ix) At least 3 cSt;
(x) At least 3.5 cSt;
(xi) At least 4 cSt;
(xii) At least 4.5 cSt.

In preferred embodiments herein the first fuel additive has a kinematic viscosity at 100° C. (as measured by ASTM D 445) in the range of from 2 cSt to 8 cSt, preferably in the range of from 3 cSt to 8 cSt, more preferably in the range of from 3.5 cSt to 6 cSt, even more preferably in the range of from 4 cSt to 6 cSt, especially in the range of from 4 cSt to 5.5 cSt, more especially in the range of from 4.5 cSt to 5.5 cSt.

In addition, the first fuel additive used in the liquid fuel composition herein has a NOACK volatility (as measured by ASTM D5800 at 250° C.) of 100 wt % or less, preferably 20 wt % or less, preferably 10 wt % or less, more preferably 6 wt % or less, even more preferably 5 wt % or less, especially 4 wt % or less.

Suitable viscosity control agents for use as the first fuel additive herein include polyalphaolefins, esters, alkyl benzenes and alkyl naphthenates. Other suitable viscosity control agents for use herein include other base lubricant oils provided they have the required kinematic viscosity and NOACK volatility. Other suitable base lubricant oils can be found in “Synthetic Lubricants and High Performance Function Fluids”, 1999, 2^{nd} Edition, edited by L R Rudnick. The viscosity control agents can be used individually or as mixtures of two or more VCAs.

Poly-alpha olefin base oils (PAOs) and their manufacture are well known in the art. Preferred poly-alpha olefin base oils that may be used in the fuel compositions of the present invention may be derived from linear C₂ to C₃₂, preferably C₆ to C₁₆, alpha olefins. Particularly preferred feedstocks for said poly-alpha olefins are 1-octene, 1-decene, 1-dodecene and 1-tetradecene. Poly-alpha olefins can be prepared from single component streams or mixed component streams.

Suitable polyalphaolefins for use herein include PAO-5, PAO-2, PAO-4, PAO-6 and PAO-8, preferably PAO-5.

Commercially available polyalphaolefins for use herein include those available from Ineos under the tradenames Durasyn 125, Durasyn 126, Durasyn 127, Durasyn 128, Durasyn 145, Durasyn 147, Durasyn 148, Durasyn 156, Durasyn 162, Durasyn 164, Durasyn 165, Durasyn 166, Durasyn 168, Durasyn 170 and Durasyn 174; those available from Exxon Mobil Corporation under the tradename Spectrasyn 4, Spectrasyn 5, Spectrasyn 6, Spectrasyn 8 and Spectrasyn 10; those available from Chevron Corporation under the tradenames Synfluid PAO 2, Synfluid PAO 4, Synfluid PAO 5, Synfluid PAO 6, Synfluid PAO 7, Synfluid PAO 8 and Synfluid PAO 9; and those commercially available from Neste under the tradenames Nexbase 2002, Nexbase 2004, Nexbase 2006 and Nexbase 2008.

Ester compounds for use herein may be used alone or as mixtures of one or more esters. Preferably the ester compounds for use herein have a molecular weight of 200 or greater, or has at least 10 carbon atoms, or has both.

Examples of esters that may be used are lower alkyl esters, such as methyl esters, of saturated or unsaturated monocarboxylic acids. Such esters may, for example, be obtained by saponification and esterification of natural fats and oils of plant or animal origin or by their transesterification with lower aliphatic alcohols.

Suitable acids from which the esters are derived include mono or polycarboxylic acids such as aliphatic, saturated or unsaturated, straight or branched chain, mono and dicarboxylic acids being preferred. For example, the acid may be generalised by the formula R′(COOH)ₓ where x represents an integer and is 1 or more such as 1, 2, 3 or 4, and R′ represents a hydrocarbyl group having from 2 to 50 carbon atoms and which is mono or polyvalent corresponding to the value of x, the —COOH groups, when more than one is present, optionally being substituent on different carbon atoms from one another.

As used in the context of the acids from which the esters are derived the term ‘Hydrocarbyl’ means a group containing carbon and hydrogen which group is connected to the rest of the molecule via a carbon atom. It may be straight or branched chain which chain may be interrupted by one or more hetero atoms such as O, S, N or P, may be saturated or unsaturated, may be aliphatic or alicyclic or aromatic including heterocyclic, or may be substituted or unsubstituted. Preferably, when the acid is monocarboxylic, the hydrocarbyl group is an alkyl group or an alkenyl group having 6 (e.g. 12) to 30 carbon atoms, i.e. the acid is saturated or unsaturated. The alkenyl group may have one or more double bonds, such as 1, 2 or 3. Examples of saturated carboxylic acids are those with 6 to 22 carbon atoms such as caproic, caprylic, capric, lauric, myristic, palmitic, and behenic acids and examples of unsaturated carboxylic acids are those with 10 to 22 carbon atoms such as oleic, elaidic, palmitoleic, petroselic, ricinoleic, eleostearic, linoleic, linolenic, eicosanoic, galoleic, erucic and hypogeic acids. When the acid is polycarboxylic, having for example from 2 to 4 carboxy groups, the hydrocarbyl group is preferably a substituted or unsubstituted polymethylene. Examples of polycarboxylic acids include adipic acid, sebacic acid, azelaic acid, phthalic acid, fumaric acid and dimer acids or di-linoleic acid commercially available as Unidyme 22 from Arizona Chemical.

The alcohol from which the ester is derived may be a mono or polyhydroxy alcohol such as a trihydroxy or tetrahydroxy alcohol. For example, the alcohol may be generalised by the formula R²(OH)_{y} where y represents an integer and is 1 or more and R² represents a hydrocarbyl group having 1 or more carbon atoms such as up to 10 carbon atoms, and which is mono or polyvalent corresponding to the value of y, the —OH groups, when more than one is present, optionally being substituent on different carbon atoms from one another.

The term ‘Hydrocarbyl’ in the context of the alcohol has the same meaning as given above for the acid. For the alcohol, the hydrocarbyl group is preferably an alkyl group or a substituted or unsubstituted polymethylene group. Examples of monohydric alcohols are lower alkyl alcohols in which the alkyl group may be straight chain or branched having from 1 to 8 carbon atoms such as methyl, ethyl, propyl, butyl, pentyl, octyl and 2-ethylhexyl alcohols.

Examples of polyhydric alcohols are aliphatic, saturated or unsaturated, straight chain or branched alcohols having 2 to 10, preferably 2 to 6, more preferably 2 to 4, hydroxy groups, and having 2 to 90, preferably 2 to 30, more preferably 2 to 12, most preferably 2 to 6, carbon atoms in the molecule. As more particular examples the polyhydric alcohol may be a glycol or diol such as neopentylglycol (NPG), or a trihydric alcohol such as glycerol or trimethylolpropane (TMP) or tetrahydric alcohol such as pentaerythritol (PE). Examples of esters of polyhydric alcohols that may be used are those where all of the hydroxy groups are esterified, those where not all of the hydroxy groups are esterified, ie the ester may have one or more free hydroxy groups, and mixtures thereof. Preferably all of the hydroxy groups are esterified. Specific examples are esters prepared from trihydric alcohols and one or more of the above-mentioned saturated or unsaturated carboxylic acids, such as TMP monoesters, TMP diesters, and TMP triesters e.g. TMP monooleate, TMP dioleate, TMP tricaproate, glycerol monooleate, glycerol dioleate and glycerol tricaproate. The alcohols may be esterified with two or more different acids. Such polyhydric esters may be prepared by esterification as described in the art and/or may be commercially available.

Examples of suitable esters for use herein include the dimerate esters commercially available under the tradenames Priolube 1858, Priolube 3967, Emkarate 1220, Emkarate 9200, Emkarate 1120 and Emkarate 1090 from Croda Europe, Palatinol 9P from BASF and Hatcol 2949 from Chemtura, Uniflex 102e from Arizona Chemical; monoesters commercially available under the tradename Synative ES EHO from Cognis (now BASF), pentaerythritol esters commercially available under the tradenames Priolube 1445 and Priolube 3987 from Croda Europe; trimellitate esters commercially available under the tradenames Emkarate 7930, Emkarate 3030, Emkarate 1030, Emkarate 8030 and Priolube 1941 from Croda Europe; trimethylolpropane esters commercially available under the tradenames Priolube 1427, Priolube 3970 and Priolube 3988 from Croda Europe, Synative ES TMP 05 from Cognis GmbH and Radialube 7364, Radialube 7365 and Radialube 3988 from Oleon; and polyol esters commercially available under the tradenames Priolube 1426, Priolube 1973 from Croda Europe, Radialube 7304 from Oleon nv, and EsterexNP343, EsterexNP372, EsterexNP451, EsterexNP671 and EsterexNP396 from Exxon Mobil Corporation.

Preferred ester compounds for use herein include esters of neopentylglycol (NPG), trimethylolpropane, or pentaerythritol. A particularly preferred ester compound for use herein is a C7-C9 ester of trimethylolpropane commercially available under the tradename Priolube 3970 from Croda Europe Limited. Another particular preferred ester compound for use herein is a cocoate/C8-C10 ester of neopentylglycol commercially available under the tradename Synative ES 3824 from Cognis (now BASF) or Nycobase 8210 from Nyco.

Another particularly preferred ester for use herein is the diester diisodecylazelate such as Priolube 1858 commercially available from Croda.

Another particular preferred ester for use herein is the monoester 2-ethylhexyl oleate commercially available under the tradename Synative ES EHO from Cognis (now BASF).

Alkyl naphthenates and their preparation are known in the art. Suitable alkyl-substituted naphthalenes include alpha-methylnaphthalene, dimethylnaphthalene and ethylnaphthalene. Suitable alkyl naphthenates for use herein and their preparation methods include, but are not necessarily limited to, those disclosed in US2004/0018944, WO02/04578, U.S. Pat. No. 5,502,086 and EP-A-0,496,486. Examples of commercially available alkyl naphthenates include those from Exxon Mobil Corporation under the tradenames Synesstic 5 and Synesstic 12, and those from King Industries, Inc. under the tradenames NA-LUBE KR008 and NA-LUBE KR019.

Alkyl benzenes and their preparation are known in the art. Suitable alkyl benzenes for use herein include, but are not necessarily limited to, those disclosed in WO02/04578, U.S. Pat. No. 5,502,086 and EP-A-0,496,486.

Preferably, the amount of the first fuel additive having a viscosity of less than 27 cSt and a NOACK volatility of 100% wt or less, preferably 20% wt or less, present in the liquid fuel composition of the present invention is at least 5 ppmw (parts per million by weight), based on the overall weight of the liquid fuel composition. More preferably, the amount of first fuel additive present in the liquid fuel composition of the present invention additionally accords with one or more of the parameters (i) to (xx) listed below:

(i) at least 10 ppmw
(ii) at least 20 ppmw
(iii) at least 30 ppmw
(iv) at least 40 ppmw
(v) at least 50 ppmw
(vi) at least 100 ppmw
(vii) at least 200 ppmw
(viii) at least 300 ppmw
(ix) at least 400 ppmw
(x) at least 500 ppmw
(xi) at least 600 ppmw
(xii) at least 700 ppmw
(xiii) at least 800 ppmw
(xiv) at least 900 ppmw
(xv) at least 1000 ppmw
(xvi) at least 2500 ppmw
(xvii) at most 5000 ppmw
(xviii) at most 10000 ppmw
(xix) at most 2% wt.
(xx) at most 5% wt.

It should be noted that the base fuel may already contain minor amounts of fuel additives, such as alkyl benzenes or alkyl naphthenates, and the amount of at least 10 ppmw, and each of the amounts listed in (i)-(xx) above is in addition to any minor amounts of such fuel additives which may already be present in the base fuel.

The liquid fuel compositions of the present invention further comprise, as an essential component, a second fuel additive which is selected from one or more friction modifiers.

Preferably, the amount of the second fuel additive in the liquid fuel composition of the present invention is at least 10 ppmw (parts per million by weight), based on the overall weight of the liquid fuel composition. More preferably, the amount of second fuel additive present in the liquid fuel composition of the present invention additionally accords with one or more of the parameters (i) to (xvi) listed below:

(i) at least 25 ppmw
(ii) at least 50 ppmw
(iii) at least 75 ppmw
(iv) at least 100 ppmw
(v) at least 150 ppmw
(vi) at least 200 ppmw
(vii) at least 300 ppmw
(viii) at least 400 ppmw
(ix) at least 500 ppmw
(x) at least 750 ppmw
(xi) at least 1000 ppmw
(xii) at least 2500 ppmw
(xiii) at most 5000 ppmw
(xiv) at most 10000 ppmw
(xv) at most 2% wt.
(xvi) at most 5% wt.

Suitable friction modifiers for use herein include esters or nitrogen derivatives of alkoxyamines (eg diethanolamine (DEA), aminoethylethanolamine (AEEA)); poly(hydroxycarboxylic) acid amide salt derivatives; poly(hydroxycarboxylic acid) derivatives having a terminal acid group e.g. poly-12-hydroxystearic acid; poly(hydroxycarboxylic acid) derivatives e.g. poly-12-hydroxystearate esters; polyetheramines; esters or nitrogen derivatives of hydroxy polycarboxylic acids (eg tartaric acid, citric acid); esters of alkylsuccinic acids eg dodecenylsuccinnates, polyisobutenylsuccinates; nitrogen derivatives of carboxylic acids, eg amine salts; esters of carboxylic acids (eg glycerol esters, glycerol mono oleate eg Priolube 1407 from Croda Chemicals); alkoxylated alcohols eg ethoxylated alcohols, propoxylated alcohols, butoxylated alcohols, such as commercially available under the NEODOL tradename from Shell Chemicals; alkoxylated amines eg ethoxylated amines, propoxylated amines, butoxylated amines such as those commercially from Akzo-Nobel under the tradename Ethomeen and Propomeen; alkoxylated amides or esters, eg propoxylated ester and/or amides of alkyl DEA or alkyl AEEA.

Preferred friction modifiers for use herein are hyperdispersants selected from poly(hydroxycarboxylic) acid amide salt derivatives, poly(hydroxycarboxylic acid) derivatives having a terminal acid group, poly(hydroxycarboxylic acid) derivatives, and polyetheramines; nitrogen derivatives of alkoxyamines, alkoxylated amides or esters; and alkoxylated amines.

Examples of suitable friction modifiers for use herein can be found in the following patent publications: US-A-7435272, U.S. Pat. No. 6,866,690, WO2002/079353, WO2010/05921, WO2009/50256, WO2010/05720, WO2002/79353, WO2010/139994, WO97/45507, WO2002/02720, WO2010/012756, WO2010/012763, and PCT applications PCT/EP2010/070762 and PCT/EP2010/070762.

Suitable types of hyperdispersants for use herein include those disclosed in WO2010/012756, WO2010/012763, PCT application number PCT/EP2010/070723 and PCT/EP2010/070762.

A preferred type of hyperdispersant for use herein are poly(hydroxycarboxylic acid) amide salt derivatives having formula (III):

[Y—CO[O-A-CO]ₙ—Zᵣ—R⁺]ₘpX^{q-} (III)

wherein Y is hydrogen or optionally substituted hydrocarbyl group, A is a divalent optionally substituted hydrocarbyl group, n is from 1 to 100, m is from 1 to 4, q is from 1 to 4 and p is an integer such that pq=m, Z is an optionally substituted divalent bridging group which is attached to the carbonyl group through a nitrogen atom, r is 0 or 1, R⁺ is an ammonium group and X^{q-} is an anion.

R⁺ may be a primary, secondary, tertiary or quaternary ammonium group. R⁺ is preferably a quaternary ammonium group.

In formula (III), A is preferably a divalent straight chain or branched hydrocarbyl group as hereafter described for formulae (I) and (II) below.

That is to say, in formula (III), A is preferably an optionally substituted aromatic, aliphatic or cycloaliphatic straight chain or branched divalent hydrocarbyl group. More preferably, A is an arylene, alkylene or alkenylene group, in particular an arylene, alkylene or alkenylene group containing in the range of from 4 to 25 carbon atoms, more preferably in the range of from 6 to 25 carbon atoms, more preferably in the range of from 8 to 24 carbon atoms, more preferably in the range of from 10 to 22 carbon atoms, and most preferably in the range of from 12 to 20 carbon atoms.

Preferably, in said compound of formula (III), there are at least 4 carbon atoms, more preferably at least 6 carbon atoms, and even more preferably in the range of from 8 to 14 carbon atoms connected directly between the carbonyl group and the oxygen atom derived from the hydroxyl group.

In the compound of formula (III), the optional substituents in the group A are preferably selected from hydroxy, halo or alkoxy groups, especially C₁₋₄ alkoxy groups.

In formula (III) (and formula (I)), n is in the range of from 1 to 100. Preferably, the lower limit of the range for n is 1, more preferably 2, even more preferably 3; preferably the upper limit of the range for n is 100, more preferably 60, more preferably 40, more preferably 20, and even more preferably 10 (i.e. n may be selected from any of the following ranges: from 1 to 100; from 2 to 100; from 3 to 100; from 1 to 60; from 2 to 60; from 3 to 60; from 1 to 40; from 2 to 40; from 3 to 40; from 1 to 20; from 2 to 20; from 3 to 20; from 1 to 10; from 2 to 10; and, from 3 to 10).

In formula (III), Y is preferably an optionally substituted hydrocarbyl group as hereinafter described for formula (I).

That is to say, the optionally substituted hydrocarbyl group Y in formula (III) is preferably aryl, alkyl or alkenyl containing up to 50 carbon atoms, more preferably in the range of from 7 to 25 carbon atoms. For example, the optionally substituted hydrocarbyl group Y may be conveniently selected from heptyl, octyl, undecyl, lauryl, heptadecyl, heptadenyl, heptadecadienyl, stearyl, oleyl and linoleyl.

Other examples of said optionally substituted hydrocarbyl group Y in formula (III) herein include C₄₋₈ cycloalkyls such as cyclohexyl; polycycloalkyls such as polycyclic terpenyl groups which are derived from naturally occurring acids such as abietic acid; aryls such as phenyl; aralkyls such as benzyl; and polyaryls such as naphthyl, biphenyl, stibenyl and phenylmethylphenyl.

In the present invention, the optionally substituted hydrocarbyl group Y in formula (III) may contain one or more functional groups such as carbonyl, carboxyl, nitro, hydroxy, halo, alkoxy, amino, preferably tertiary amino (no N—H linkages), oxy, cyano, sulphonyl and sulphoxyl. The majority of the atoms, other than hydrogen, in substituted hydrocarbyl groups are generally carbon, with the heteroatoms (e.g., oxygen, nitrogen and sulphur) generally representing only a minority, about 33% or less, of the total non-hydrogen atoms present.

Those skilled in the art will appreciate that functional groups such as hydroxy, halo, alkoxy, nitro and cyano in a substituted hydrocarbyl group Y will displace one of the hydrogen atoms of the hydrocarbyl, whilst functional groups such as carbonyl, carboxyl, tertiary amino (—N—), oxy, sulphonyl and sulphoxyl in a substituted hydrocarbyl group will displace a —CH— or —CH₂— moiety of the hydrocarbyl.

More preferably, the hydrocarbyl group Y in formula (III) is unsubstituted or substituted by a group selected from hydroxy, halo or alkoxy group, even more preferably C₁₋₄ alkoxy.

Most preferably, the optionally substituted hydrocarbyl group Y in formula (III) is a stearyl group, 12-hydroxystearyl group, an oleyl group or a 12-hydroxyoleyl group, and that derived from naturally occurring oil such as tall oil fatty acid.

In formula (III), Z is an optionally substituted divalent bridging group, preferably of the formula —X^{Z}—B—Y^{Z}_{q}—, wherein X^{Z} is selected from oxygen, sulphur or a group of the formula —NR¹—, wherein R¹ is as described below, B is as described below, Y^{Z} is selected from oxygen or a group of the formula —NR′—, wherein R¹ is as described below, and q is 0 or 1. If q is 1 and both X^{Z} and Y^{Z} are groups of the formula —NR¹—, then the two R¹ groups may form a single hydrocarbyl group linking the two nitrogen atoms.

In formula (III), Z is preferably an optionally substituted divalent bridging group represented by formula (IV)

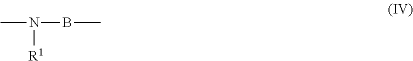

wherein R¹ is hydrogen or a hydrocarbyl group and B is an optionally substituted alkylene group.

Examples of hydrocarbyl groups that may represent R¹ include methyl, ethyl, n-propyl, n-butyl and octadecyl.

Examples of optionally substituted alkylene groups that may represent B include ethylene, trimethylene, tetramethylene and hexamethylene.

Examples of preferred Z moieties in formula (III) include —NHCH₂CH₂—, —NHCH₂C(CH₃)₂CH₂— and —NH(CH₂)₃—.

In formula (III), r is preferably 1, i.e. the poly(hydroxycarboxylic acid) amide salt derivative having formula (III) must contain the optionally substituted divalent bridging group Z.

Preferably, R⁺ may be represented by formula (V)

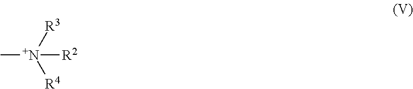

wherein R², R³ and R⁴ may be selected from hydrogen and alkyl groups such as methyl.

The anion X^{q-} of the compound of formula (III) is not critical and can be any anion (or mixture of anions) suitable to balance the positive charge of the poly(hydroxycarboxylic acid) amide cation.

The anion X^{q-} of the compound of formula (III) may conveniently be a sulphur-containing anion, such as an anion selected from sulphate and sulphonate anions.

However, since it is desirable to maintain a low sulphur content in gasoline and diesel fuels, the use of non-sulphur-containing anions in the compounds of formula (III) may be desirable depending upon the concentration of sulphur in the liquid base fuel and/or the desired concentration of sulphur in the liquid fuel composition containing the one or more poly(hydroxycarboxylic acid) amide salt derivatives.

Therefore, the anion X^{q-} of the compound of formula (III) can also be any non-sulphur-containing anion (or mixture of anions) suitable to balance the positive charge of the poly(hydroxycarboxylic acid) amide cation, such as a non-sulphur-containing organic anion or a non-sulphur-containing inorganic anion.

Non-limiting examples of suitable anions are OH⁻, CH⁻, NH₃⁻, HCO₃⁻, HCOO⁻, CH₃COO⁻, H⁻, BO₃³⁻, CO₃²⁻, C₂H₃O₂⁻, HCO²⁻, C₂O₄²⁻, HC₂O₄⁻, NO₃⁻, NO₂⁻, N³⁻, NH₂⁻, O²⁻, O₂²⁻, BeF₃⁻, F⁻, Na⁻, [Al(H₂O)₂ (OH)₄]⁻, SiO₃²⁻, SiF₆²⁻, H₂PO₄⁻, P³⁻, PO₄³⁻, HPO₄²⁻, Cl⁻, ClO₃⁻, ClO₄⁻, ClO⁻, KO⁻, SbOH₆⁻, SnCl₆²⁻, [SnTe4]⁴⁻, CrO₄²⁻, Cr₂O₇²⁻, MnO₄⁻, NiCl₆²⁻, [Cu(CO₃)₂(OH)₂]⁴⁻, AsO₄³⁻, Br⁻, BrO₃⁻, IO₃⁻, I⁻, CN⁻, OCN⁻, etc.

Suitable anions may also include anions derived from compounds containing a carboxylic acid group (e.g. a carboxylate anion), anions derived from compounds containing a hydroxyl group (e.g. an alkoxide, phenoxide or enolate anion), nitrogen based anions such as nitrate and nitrite, phosphorus based anions such as phosphates and phosphonates, or mixtures thereof.

Non-limiting examples of suitable anions derived from compounds containing a carboxylic acid group include acetate, oleate, salicylate anions, and mixtures thereof.

Non-limiting examples of suitable anions derived from compounds containing a hydroxyl group include phenate anions, and mixtures thereof.

In a preferred embodiment of the present invention, the anion X^{q-} is a non-sulfur-containing anion selected from the group consisting of OH, a phenate group, a salicylate group, an oleate group and an acetate group; more preferably the anion X^{q-} is OH.

The one or more poly(hydroxycarboxylic acid) amide salt derivatives may be obtained by reaction of an amine and a poly(hydroxycarboxylic acid) of formula (I)

Y—CO[O-A-CO]ₙ—OH (I)

wherein Y is hydrogen or optionally substituted hydrocarbyl group, A is a divalent optionally substituted hydrocarbyl group and n is from 1 to 100, with an acid or a quaternizing agent.

As used herein in relation to formulae (I), (II), (III), (IV), (V), (VI) and (VII), the term “hydrocarbyl” represents a radical formed by removal of one or more hydrogen atoms from a carbon atom of a hydrocarbon (not necessarily the same carbon atoms in case more hydrogen atoms are removed).

Hydrocarbyl groups may be aromatic, aliphatic, acyclic or cyclic groups. Preferably, hydrocarbyl groups are aryl, cycloalkyl, alkyl or alkenyl, in which case they may be straight-chain or branched-chain groups.

Representative hydrocarbyl groups include phenyl, naphthyl, methyl, ethyl, butyl, pentyl, methylpentyl, hexenyl, dimethylhexyl, octenyl, cyclooctenyl, methylcyclooctenyl, dimethylcyclooctyl, ethylhexyl, octyl, isooctyl, dodecyl, hexadecenyl, eicosyl, hexacosyl, triacontyl and phenylethyl.

In the present invention, the phrase “optionally substituted hydrocarbyl” is used to describe hydrocarbyl groups optionally containing one or more “inert” heteroatom-containing functional groups. By “inert” is meant that the functional groups do not interfere to any substantial degree with the function of the compound.

The optionally substituted hydrocarbyl group Y in formula (I) herein is preferably aryl, alkyl or alkenyl containing up to 50 carbon atoms, more preferably in the range of from 7 to 25 carbon atoms. For example, the optionally substituted hydrocarbyl group Y may be conveniently selected from heptyl, octyl, undecyl, lauryl, heptadecyl, heptadenyl, heptadecadienyl, stearyl, oleyl and linoleyl.

Other examples of said optionally substituted hydrocarbyl group Y in formula (I) herein include C₄₋₈ cycloalkyls such as cyclohexyl; polycycloalkyls such as polycyclic terpenyl groups which are derived from naturally occurring acids such as abietic acid; aryls such as phenyl; aralkyls such as benzyl; and polyaryls such as naphthyl, biphenyl, stibenyl and phenylmethylphenyl.

In the present invention, the optionally substituted hydrocarbyl group Y may contain one or more functional groups such as carbonyl, carboxyl, nitro, hydroxy, halo, alkoxy, tertiary amino (no N—H linkages), oxy, cyano, sulphonyl and sulphoxyl. The majority of the atoms, other than hydrogen, in substituted hydrocarbyl groups are generally carbon, with the heteroatoms (e.g., oxygen, nitrogen and sulphur) generally representing only a minority, about 33% or less, of the total non-hydrogen atoms present.

Those skilled in the art will appreciate that functional groups such as hydroxy, halo, alkoxy, nitro and cyano in a substituted hydrocarbyl group Y will displace one of the hydrogen atoms of the hydrocarbyl, whilst functional groups such as carbonyl, carboxyl, tertiary amino (—N—), oxy, sulphonyl and sulphoxyl in a substituted hydrocarbyl group will displace a —CH— or —CH₂— moiety of the hydrocarbyl.

The hydrocarbyl group Y in formula (I) is more preferably unsubstituted or substituted by a group selected from hydroxy, halo or alkoxy group, even more preferably C₁₋₄ alkoxy.

Most preferably, the optionally substituted hydrocarbyl group Y in formula (I) is a stearyl group, 12-hydroxystearyl group, an oleyl group, a 12-hydroxyoleyl group or a group derived from naturally occurring oil such as tall oil fatty acid.

In one embodiment of the present invention, at least one of, or all of, the one or more poly(hydroxycarboxylic acid) amide salt derivatives of formula (III) are sulphur-containing poly(hydroxycarboxylic acid) amide salt derivatives.

In such an embodiment, said one or more poly(hydroxycarboxylic acid) amide salt derivatives preferably have a sulphur content of at most 2.5 wt. %, such as a sulphur content in the range of from 0.1 to 2.0 wt. %, conveniently in the range of from 0.6 to 1.2 wt. % sulphur, as measured by ICP-AES, based on the total weight of said poly(hydroxycarboxylic acid) amide salt derivatives.

In another embodiment of the present invention, the one or more poly(hydroxycarboxylic acid) amide salt derivatives are non-sulphur-containing poly(hydroxycarboxylic acid) amide salt derivatives.

The preparation of poly(hydroxycarboxylic acid) and its amide or other derivatives is known and is described, for instance, in EP 0 164 817, WO 95/17473, WO 96/07689, U.S. Pat. No. 5,536,445, GB 2 001 083, GB 1 342 746, GB 1 373 660, U.S. Pat. No. 5,000,792 and U.S. Pat. No. 4,349,389.

The poly(hydroxycarboxylic acid)s of formula (I) may be made by the interesterification of one or more hydroxycarboxylic acids of formula (II)

HO-A-COOH (II)

wherein A is a divalent optionally substituted hydrocarbyl group, optionally in the presence of a catalyst according to well known methods. Such methods are described, for example, in U.S. Pat. No. 3,996,059, GB 1 373 660 and GB 1 342 746.

The chain terminator in said interesterification may be a non-hydroxycarboxylic acid.

The hydroxyl group in the hydroxycarboxylic acid and the carboxylic acid group in the hydroxycarboxylic acid or the non-hydroxycarboxylic acid may be primary, secondary or tertiary in character.

The interesterification of the hydroxycarboxylic acid and the non-hydroxycarboxylic acid chain terminator may be effected by heating the starting materials, optionally in a suitable hydrocarbon solvent such as toluene or xylene, and azeotroping off the formed water. The reaction may be carried out at a temperature up to −250° C., conveniently at the reflux temperature of the solvent.

Where the hydroxyl group in the hydroxycarboxylic acid is secondary or tertiary, the temperature employed should not be so high as to lead to dehydration of the acid molecule.

Catalysts for the interesterification, such as p-toluenesulphonic acid, zinc acetate, zirconium naphthenate or tetrabutyl titanate, may be included, with the objective of either increasing the rate of reaction at a given temperature or of reducing the temperature required for a given rate of reaction.

In the compounds of formulae (I) and (II), A is preferably an optionally substituted aromatic, aliphatic or cycloaliphatic straight chain or branched divalent hydrocarbyl group. Preferably, A is an arylene, alkylene or alkenylene group, in particular an arylene, alkylene or alkenylene group containing in the range of from 4 to 25 carbon atoms, more preferably in the range of from 6 to 25 carbon atoms, more preferably in the range of from 8 to 24 carbon atoms, more preferably in the range of from 10 to 22 carbon atoms, and most preferably in the range of from 12 to 20 carbon atoms.

Preferably, in said compounds of formulae (I) and (II), there are at least 4 carbon atoms, more preferably at least 6 carbon atoms, and even more preferably in the range of from 8 to 14 carbon atoms connected directly between the carbonyl group and the oxygen atom derived from the hydroxyl group.

In the compounds of formulae (I) and (II), the optional substituents in the group A are preferably selected from hydroxy, halo or alkoxy groups, more preferably C₁₋₄ alkoxy groups.

The hydroxyl group in the hydroxycarboxylic acids of formula (II) is preferably a secondary hydroxyl group.

Examples of suitable hydroxycarboxylic acids are 9-hydroxystearic acid, 10-hydroxystearic acid, 12-hydroxystearic acid, 12-hydroxy-9-oleic acid (ricinoleic acid), 6-hydroxycaproic acid, preferably 12-hydroxystearic acid. Commercial 12-hydroxystearic acid (hydrogenated castor oil fatty acid) normally contains up to 15% wt of stearic acid and other non-hydroxycarboxylic acids as impurities and can conveniently be used without further admixture to produce a polymer of molecular weight about 1000-2000.

Where the non-hydroxycarboxylic acid is introduced separately to the reaction, the proportion which is required in order to produce a polymer or oligomer of a given molecular weight can be determined either by simple experiment or by calculation by the person skilled in the art.

The group (—O-A-CO—) in the compounds of formulae (I) and (II) is preferably a 12-oxystearyl group, 12-oxyoleyl group or a 6-oxycaproyl group.

Preferred poly(hydroxycarboxylic acid)s of formula (I) for reaction with amine include poly(hydroxystearic acid) and poly(hydroxyoleic acid).

The amines which react with poly(hydroxycarboxylic acid)s of formula (I) to form poly(hydroxycarboxylic acid) amide intermediates may include those defined in WO 97/41092.

For example, various amines and their preparations are described in U.S. Pat. No. 3,275,554, U.S. Pat. No. 3,438,757, U.S. Pat. No. 3,454,555, U.S. Pat. No. 3,565,804, U.S. Pat. No. 3,755,433 and U.S. Pat. No. 3,822,209.

The amine reactant is preferably a diamine, a triamine or a polyamine.

Preferred amine reactants are diamines selected from ethylenediamine, N,N-dimethyl-1,3-propanediamine, triamines and polyamines selected from dietheylenetriamine, triethylenetetramine, tetraethylenepentamine, pentaethylenehexamine and tris(2-aminoethyl)amine.

The amidation between the amine reactant and the (poly(hydroxycarboxylic acid) of formula (I) may be carried out according to methods known to those skilled in the art, by heating the poly(hydroxycarboxylic acid) with the amine reactant, optionally in a suitable hydrocarbon solvent such as toluene or xylene, and azeotroping off the formed water. Said reaction may be carried out in the presence of a catalyst such as p-toluenesulphonic acid, zinc acetate, zirconium naphthenate or tetrabutyl titanate.

Various patent documents disclose poly(hydroxycarboxylic acid) amide derivatives.

For instance, GB 1 373 660 discloses poly(hydroxycarboxylic acid) amide derivatives with amines such as 3-dimethylaminopropylamine and ethylenediamine for use as dispersing agents in dispersions of pigments in organic liquids.

GB 2 001 083 discloses poly(hydroxycarboxylic acid) amide derivatives with poly(ethyleneimine) (PEI) having a molecular weight (MW) greater than 500 for a similar use.

In U.S. Pat. No. 5,000,792, poly(hydroxycarboxylic acid) amide derivatives with amines of the formula of NH₂—R′—N(R″)—R′″-NH₂ are disclosed for use as pigment dispersing agent.

WO 95/17473 discloses poly(hydroxycarboxylic acid) amide derivatives with amines such as 3-dimethylaminopropylamine, ethylenediamine, poly(ethyleneimine) (PEI) having a molecular weight (MW) greater than 500 and amines of the formula of NH₂—R′—N(R″)—R′″-NH₂ for use in a method of preparing a non-aqueous dispersion of copper phthalocyanine.

U.S. Pat. No. 4,349,389 discloses poly(hydroxycarboxylic acid) amide derivatives with amines such as 3-dimethylaminopropylamine, poly(ethyleneimine) (PEI) having a molecular weight (MW) greater than 500 as dispersing agent in the preparation of a dispersible inorganic pigment composition.

EP 0 164 817 discloses poly(hydroxycarboxylic acid) amide derivatives with polyamines (ethylenediamine, diethylenetriamine, etc.), aminoalcohols (diethanolamine, etc.) and ester derivatives with polyols (glycerol, etc.) for use as surfactant suitable for stabilising dispersions of solids in organic liquids and oil/water emulsions.

However, none of the afore-mentioned patent documents disclose the use of one or more poly(hydroxycarboxylic acid) amide salt derivatives as disclosed herein in fuel compositions.

The poly(hydroxycarboxylic acid) amide intermediate formed from reaction of the amine and the poly(hydroxycarboxylic acid) of formula (I) is reacted with an acid or a quaternizing agent to form a salt derivative, according to well-known methods.

Acids that may be used to form the salt derivative may be selected from organic or inorganic acids. Said acids are conveniently selected from carboxylic acids, nitrogen-containing organic and inorganic acids, sulphur-containing organic or inorganic acids (such as sulphuric acid, methanesulphonic acid and benzenesulphonic acid).

Quaternizing agents that may be used to form the salt derivative may be selected from dimethylsulphuric acid, a dialkyl sulphate having from 1 to 4 carbon atoms, an alkyl halide such as methyl chloride, methyl bromide, aryl halide such as benzyl chloride.

In a preferred embodiment, the quaternizing agent is a sulphur-containing quaternizing agent, in particular dimethylsulphuric acid or an dialkyl sulphate having from 1 to 4 carbon atoms. The quaternizing agent is preferably dimethyl sulphate.

Quaternization is a well-known method in the art. For example, quaternization using dimethyl sulphate is described in U.S. Pat. No. 3,996,059, U.S. Pat. No. 4,349,389 and GB 1 373 660.

Poly(hydroxycarboxylic acid) amide salt derivatives that are preferred in the present invention are those which each have a TBN (total base number) value of less than 10 mg·KOH/g, as measured by ASTM D 4739. More preferably, the poly(hydroxycarboxylic acid) amide salt derivatives each have a TBN value of less than 5 mg·KOH/g, most preferably 2 mg·KOH/g or less, as measured by ASTM D 4739.

Examples of poly(hydroxycarboxylic acid) amide salt derivatives having a formula (III) that are available commercially include that available from Lubrizol under the trade designation “SOLSPERSE 17000” (a reaction product of poly(12-hydroxystearic acid) with N,N-dimethyl-1,3-propanediamine and dimethyl sulphate) and those available under the trade designations “CH-5” and “CH-7” from Shanghai Sanzheng Polymer Company.

Another type of hyperdispersant which is suitable for use herein is poly(hydroxycarboxylic acid) derivative having a terminal acid group having formula (Va):

[Y—CO[O-A-CO]ₙ—Zᵣ]ₛ—X (Va)

wherein Y, A, Z and r have the same definitions as given above for formula (III), including any preferences and optional substituents thereof, m is 1 or 2, and X is terminal acid group or a group carrying a terminal acid group, wherein the terminal acid group is selected from carboxylic acid, carboxymethyl, sulphate, sulphonate, phosphate and phosphonate.

Preferably, in said compound of formula (Va), there are at least 4 carbon atoms, more preferably at least 6 carbon atoms, and even more preferably in the range of from 8 to 14 carbon atoms connected directly between the carbonyl group and the oxygen atom derived from the hydroxyl group.

In formula (Va), X is terminal acid group or a group carrying a terminal acid group, wherein the terminal acid group is selected from carboxylic acid, carboxymethyl, sulphate, sulphonate, phosphate and phosphonate. If X is a group carrying a terminal acid group, then preferably it is a group of the formula —Z¹—X¹, wherein Z¹ is a bifunctional linking compound, such as a compound selected from a polyamine, polyol, hydroxylamine, or a Z group as defined above, and X¹ is a terminal acid group selected from carboxylic acid, carboxymethyl, sulphate, sulphonate, phosphate and phosphonate; more preferably, if X is a group carrying a terminal acid group, then r in formula (Va) is 0 and X is a group of the formula —Z¹—X¹.

The terminal acid group may be present in the free acid form or in the form of a salt of the acid. If the terminal acid group is in the form of a salt, it is can conveniently be formed by the reaction of the terminal acid in the free acid form with a base, for example, with ammonia, organic bases such as amines and aminoalcohols, and inorganic bases. If the acid group in the terminal acid group is a salt, then examples of suitable cations include metal ions, such as sodium, potassium and calcium, and ammonium ions, such as an ammonium ion (NH₄⁺), N(CH₃)₄⁺, and NH(CH₃)₄⁺.

The one or more poly(hydroxycarboxylic acid) derivative having a terminal acid group may be obtained by reaction of a poly(hydroxycarboxylic acid) of formula (I) as defined above with:

a compound having a group reactive with the terminal carboxylic acid group of the poly(hydroxycarboxylic acid) of formula (I) and a terminal acid group selected from carboxylic acid, carboxymethyl, sulphate, sulphonate, phosphate and phosphonate;

a precursor of the terminal acid group; or

a bifunctional linking compound which is subsequently reacted with a precursor of the terminal acid group.

Suitable compounds having a group reactive with the terminal carboxylic acid group of the poly(hydroxycarboxylic acid) of formula (I) and a terminal acid group selected from carboxylic acid, carboxymethyl, sulphate, sulphonate, phosphate and phosphonate, include alpha-amino- or alpha-hydroxy-alkane carboxylic acids, such as glycine and glycolic acid and amino- and hydroxy-organic sulphonic or phosphonic acids, such as aminoethane sulphonic acid; suitable precursors of the terminal acid group are phosphorus pentoxide and sulphonyl chloride; and, suitable bifunctional linking compounds, which can form a linking group between the polyester and the terminal acid group, are polyamines, polyols, hydroxyamines and Z groups as described above.

The reaction of a compound having a group reactive with the terminal carboxylic acid group of the poly(hydroxycarboxylic acid) of formula (I) and a terminal acid group selected from carboxylic acid, carboxymethyl, sulphate, sulphonate, phosphate and phosphonate;

a precursor of the terminal acid group; or

a bifunctional linking compound which is subsequently reacted with a precursor of the terminal acid group, with a poly(hydroxycarboxylic acid) of formula (I) is known and is described in the art, for example in EP 0 164 817.

The poly(hydroxycarboxylic acid) derivatives having a terminal acid group that are preferred in the present invention are those which each have a TBN (total base number) value of less than 60 mg·KOH/g, more preferably less than 50 mg·KOH/g, even more preferably less than 40 mg·KOH/g and most preferably less than 30 mg·KOH/g, as measured by ASTM D 4739. Conveniently, the poly(hydroxycarboxylic acid) derivatives having a terminal acid group may each have a TBN value of less than 5 mg·KOH/g, more conveniently 2 mg·KOH/g or less, as measured by ASTM D 4739.

The poly(hydroxycarboxylic acid) derivatives having a terminal acid group that are preferred in the present invention are those which each have an acid value of less than 70 mg·KOH/g, more preferably less than 60 mg·KOH/g, even more preferably less than 50 mg·KOH/g and most preferably less than 40 mg·KOH/g.

Another suitable hyperdispersant for use herein is a polyetheramide having formula (VI):

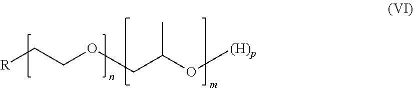

wherein R is an —NR¹₂ group where R¹ is independently selected from hydrogen and a C₁-C₆ hydrocarbyl group, n is in the range of from 6 to 37, m is in the range of from 12 to 74 and p is 0 or 1.

In formula (VI), n is preferably in the range of from 8 to 24 and m is preferably in the range of from 16 to 48. In preferred embodiments, the ratio of n:m is 1:2.

In one embodiment of the present invention, p is 1. In another embodiment of the present invention p is 0.

In formula (VI), R is a terminal amine group wherein the terminal amine group is selected from —NR¹₂, wherein R¹ is selected from hydrogen and a C₁-C₆ hydrocarbyl group.

The R¹ group in the terminal amine group is preferably independently selected from hydrogen and a C₁-C₄ hydrocarbyl group; more preferably R¹ is independently selected from a C₁-C₄ alkyl group. Examples of suitable C₁-C₄ alkyl groups are methyl, ethyl, n-propyl, i-propyl, n-butyl, i-butyl and t-butyl groups.

Examples of suitable terminal amine groups include —NH₂, —NHCH₃, —NHCH₂CH₃, —NHCH₂CH₂CH₃, —NHCH(CH₃)₂, —NHCH₂CH₂CH₂CH₃, —NHC(CH₃)₃, —N(CH₃)₂, —N(CH₃)CH₂CH₃, —N(CH₃)CH₂CH₂CH₃, —N(CH₂CH₃)₂, —N(CH₂CH₃)CH(CH₃)₂, —N(CH₂CH₃) CH₂CH₂CH₂CH₃, —N(CH₂CH₃)C(CH₃)₃, —N(CH₂CH₃) CH₂CH₃, —N(CH₂CH₃) CH₂CH₂CH₃, —N(CH₂CH₃)CH(CH₃)₂, —N(CH₂CH₃) CH₂CH₂CH₂CH₃, —N(CH₂CH₃)C(CH₃)₃, —N(CH(CH₃)₂) CH₂CH₂CH₃, —N(CH(CH₃))₂, —N(CH(CH₃)₂) CH₂CH₂CH₂CH₃, —N(CH(CH₃)₂)C(CH₃)₃, —N(CH₂CH₂CH₃) CH₂CH₃, —N(CH₂CH₂CH₃)₂, —N(CH₂CH₂CH₃) CH₂CH₂CH₂CH₃, —N(CH₂CH₂CH₃)C(CH₃)₃, —N(CH₂CH₂CH₂CH₃)₂, —N(CH₂CH₂CH₂CH₃)C(CH₃)₃, and —N(C(CH₃)₃)₂.

In a preferred embodiment of the present invention the terminal amine group is —N(CH₂CH₃)₂.

The preparation of compounds of formula (VI) is known and is described in the art, for example in WO96/00440.

Examples of polyetheramines suitable for use herein include CH-10S commercially available from Shanghai Sanzheng Polymer Material Co. Ltd (China) and Solsperse® 20000 commercially available from Lubrizol Advanced Materials Inc.

Another suitable hyperdispersant for use herein is a poly(hydroxycarboxylic acid) derivative having a terminal amine group having formula (VII):

[Y—CO[O-A-CO]ₙ—Zₚ]ₘ—X (VII)

wherein Y, A and n are as defined above for formula (III), including any preferences and optional substituents, m is 1 or 2, Z is an optionally substituted divalent bridging group, p is from 0 to 10, and X is terminal amine group or a group carrying a terminal amine group, wherein the terminal amine group is selected from —NR¹₂, wherein R¹ is independently selected from hydrogen and a C₁-C₆ hydrocarbyl group.

In formula (VII), p is selected from 0 to 10, preferably p is selected from 0 to 8, more preferably p is selected from 0 to 6. In one embodiment of the present invention, p is at least 1 (i.e. p is selected from 1 to 10, from 1 to 8, or from 1 to 6), or at least 2 (i.e. p is selected from 2 to 10, from 2 to 8, or from 2 to 6).

In formula (VII), X is terminal amine group or a group carrying a terminal amine group, wherein the terminal amine group is selected from —NR¹₂, wherein R¹ is selected from hydrogen and a C₁-C₆ hydrocarbyl group. If X is a group carrying a terminal amine group, then preferably it is a group of the formula —Z¹—X¹, wherein Z¹ is a bifunctional linking compound, such as a compound selected from a polyamine, polyol, hydroxylamine, or a Z group as defined above, and X¹ is a terminal amine group selected from —NR¹₂, wherein R¹ is selected from hydrogen and a C₁-C₆ hydrocarbyl group, if X is a group carrying a terminal acid group, then p in formula (VII) is 0 and X is a group of the formula —Z¹—X¹.

The R¹ group in the terminal amine group is preferably independently selected from hydrogen and a C₁-C₄ hydrocarbyl group; more preferably R¹ is independently selected from hydrogen and a C₁-C₄ alkyl group. Examples of suitable C₁-C₄ alkyl groups are methyl, ethyl, n-propyl, i-propyl, n-butyl, i-butyl and t-butyl groups.

Examples of suitable terminal amine groups include —NH₂, —NHCH₃, —NHCH₂CH₃, —NHCH₂CH₂CH₃, —NHCH(CH₃)₂, —NHCH₂CH₂CH₂CH₃, —NHC(CH₃)₃, —N(CH₃)₂, —N(CH₃) CH₂CH₃, —N(CH₃) CH₂CH₂CH₃, —N(CH₂CH₃)₂, —N(CH₂CH₃)CH(CH₃)₂, —N(CH₂CH₃) CH₂CH₂CH₂CH₃, —N(CH₂CH₃)C(CH₃)₃, —N(CH₂CH₃) CH₂CH₃, —N(CH₂CH₃) CH₂CH₂CH₃, —N(CH₂CH₃)CH(CH₃)₂, —N(CH₂CH₃) CH₂CH₂CH₂CH₃, —N(CH₂CH₃)C(CH₃)₃, —N(CH(CH₃)₂) CH₂CH₂CH₃, —N(CH(CH₃))₂, —N(CH(CH₃)₂) CH₂CH₂CH₂CH₃, —N(CH(CH₃)₂)C(CH₃)₃, —N(CH₂CH₂CH₃) CH₂CH₃, —N(CH₂CH₂CH₃)₂, —N(CH₂CH₂CH₃) CH₂CH₂CH₂CH₃, —N(CH₂CH₂CH₃)C(CH₃)₃, —N(CH₂CH₂CH₂CH₃)₂, —N(CH₂CH₂CH₂CH₃)C(CH₃)₃, and —N(C(CH₃)₃)₂.

In one embodiment of the present invention the terminal amine group is —NH₂.

The one or more poly(hydroxycarboxylic acid) derivative having a terminal amine group may be obtained by reaction of a poly(hydroxycarboxylic acid) of formula (I) as defined above with:

a compound having a group reactive with the terminal carboxylic acid group of the poly(hydroxycarboxylic acid) of formula (I) and a terminal amine group as defined above;

a precursor of the terminal amine group; or

a bifunctional linking compound which is subsequently reacted with a precursor of the terminal amine group.

Suitable compounds having a group reactive with the terminal carboxylic acid group of the poly(hydroxycarboxylic acid) of formula (I) and a terminal amine group, include unsubstituted and substituted amines, diamines, and polyamines, examples of substituted amines are mono-, di- and tri-alkylamines, alkyleneamines, and alpha-amino- or alpha-hydroxy-alkane amines, most suitably ethylenediamine, diethylenetriamine, triethylenetetramine, tetraethylenepentamine and pentaethylenehexamine, most preferably tetraethylenepentamine; and, suitable bifunctional linking compounds, which can form a linking group between the polyester and the terminal amine group, are polyamines, polyols, hydroxyamines and Z groups as described above.

The reaction of a compound having a group reactive with the terminal carboxylic acid group of the poly(hydroxycarboxylic acid) of formula (I) and a terminal amine group;

a precursor of the terminal amine group; or

a bifunctional linking compound which is subsequently reacted with a precursor of the terminal amine group, with a poly(hydroxycarboxylic acid) of formula (I) is known and is described in the art, for example in EP 0 164 817.

The poly(hydroxycarboxylic acid) derivatives having a terminal amine group that are preferred in the present invention are those which each have a TBN (total base number) value of at least 100 mg·KOH/g, more preferably at least 150 mg·KOH/g, even more preferably at least 175 mg·KOH/g and most preferably at least 200 mg·KOH/g, as measured by ASTM D 4739. The TBN may be at most 300 mg·KOH/g, preferably at most 250 mg·KOH/g.

The poly(hydroxycarboxylic acid) derivatives having a terminal amine group that are preferred in the present invention are those which each have an acid value of less than 20 mg·KOH/g, more preferably less than 15 mg·KOH/g, even more preferably less than 10 mg·KOH/g and most preferably less than 7 mg·KOH/g. The TAN may be at least 0 mg·KOH/g.

A preferred class of friction modifiers for use herein is nitrogen derivatives of alkoxyamines such as those disclosed in WO2009/50287, in particular, the reaction product of oleic acid and aminoethylethanolamine 3:1 molar ratio as disclosed in Example 4 of WO2009/50287.

Another preferred class of friction modifiers for use herein is alkoxylated amides or esters such as those disclosed in WO2010/05720. An example of such a friction modifier is a propoxylated ester of alkyl DEA as disclosed in WO2010/05720 and commercially available from BASF.

Examples of commercially available friction modifiers suitable for use as the second additive herein include, but are not limited to, HiTec 6457 commercially available from Afton Chemicals; Kerocom K3561 commercially available from BASF; OLI9000 and OLI9900 commercially available from Innospec; Ultrazol 9525 and Ultrazol 9555 commercially available from Lubrizol; Neodol N23-2, Neodol N25-7 and Neodol N91-5 commercially available from Shell Chemical; Ethomeen T12, Ethomeen T12e, Ethomeen T15, Ethomeen O12, Ethomeen O15, Ethomeen T20 and Ethomeen C15 commercially available from AkzoNobel; OMA4 commercially available from AkzoNobel; Amadol 128t, Amadol 61 and Amadol 5134 commercially available from AkzoNobel; Solsperse 3000, Solsperse 21000, Solperse 17000, Solsperse 13000, Solsperse 13240, Solsperse 13650, Solsperse 13940, Solsperse 20000, Solsperse 24000 and Solsperse 9000 commercially available from Lubrizol; CH2C, CH1a, CH7A, CH5, CH6, CH10S, CH13 and CH3 all commercially available from Shanghai Sanzheng Polymer Material Co. Ltd.

The first fuel additive and second fuel additive are blended together with any other additives e.g. additive performance package(s) to produce an additive blend. The additive blend is then added to a base fuel to produce a liquid fuel composition. The amount of first fuel additive in the additive blend is preferably in the range of from 0.1 to 99.8 wt %, by weight of the additive blend. The amount of second fuel additive in the additive blend is preferably in the range of from 0.1 to 99.8 wt %, by weight of the additive blend.

The amount of performance package(s) in the additive blend is preferably in the range of from 0.1 to 99.8 wt %, by weight of the additive blend.

Preferably, the amount of the performance package present in the liquid fuel composition of the present invention is in the range of 15 ppmw (parts per million by weight) to 10% wt, based on the overall weight of the liquid fuel composition. More preferably, the amount of the performance package present in the liquid fuel composition of the present invention additionally accords with one or more of the parameters (i) to (xv) listed below:

(i) at least 100 ppmw
(ii) at least 200 ppmw
(iii) at least 300 ppmw
(iv) at least 400 ppmw
(v) at least 500 ppmw
(vi) at least 600 ppmw
(vii) at least 700 ppmw
(viii) at least 800 ppmw
(ix) at least 900 ppmw
(x) at least 1000 ppmw
(xi) at least 2500 ppmw
(xii) at most 5000 ppmw
(xiii) at most 10000 ppmw
(xiv) at most 2% wt.
(xv) at most 5% wt.

In the liquid fuel compositions of the present invention, if the base fuel used is a gasoline, then the gasoline may be any gasoline suitable for use in an internal combustion engine of the spark-ignition (petrol) type known in the art, including automotive engines as well as in other types of engine such as, for example, off road and aviation engines. The gasoline used as the base fuel in the liquid fuel composition of the present invention may conveniently also be referred to as ‘base gasoline’.

Gasolines typically comprise mixtures of hydrocarbons boiling in the range from 25 to 230° C. (EN-ISO 3405), the optimal ranges and distillation curves typically varying according to climate and season of the year. The hydrocarbons in a gasoline may be derived by any means known in the art, conveniently the hydrocarbons may be derived in any known manner from straight-run gasoline, synthetically-produced aromatic hydrocarbon mixtures, thermally or catalytically cracked hydrocarbons, hydro-cracked petroleum fractions, catalytically reformed hydrocarbons or mixtures of these.

The specific distillation curve, hydrocarbon composition, research octane number (RON) and motor octane number (MON) of the gasoline are not critical.

Conveniently, the research octane number (RON) of the gasoline may be at least 80, for instance in the range of from 80 to 110, preferably the RON of the gasoline will be at least 90, for instance in the range of from 90 to 110, more preferably the RON of the gasoline will be at least 91, for instance in the range of from 91 to 105, even more preferably the RON of the gasoline will be at least 92, for instance in the range of from 92 to 103, even more preferably the RON of the gasoline will be at least 93, for instance in the range of from 93 to 102, and most preferably the RON of the gasoline will be at least 94, for instance in the range of from 94 to 100 (EN 25164); the motor octane number (MON) of the gasoline may conveniently be at least 70, for instance in the range of from 70 to 110, preferably the MON of the gasoline will be at least 75, for instance in the range of from 75 to 105, more preferably the MON of the gasoline will be at least 80, for instance in the range of from 80 to 100, most preferably the MON of the gasoline will be at least 82, for instance in the range of from 82 to 95 (EN 25163).

Typically, gasolines comprise components selected from one or more of the following groups; saturated hydrocarbons, olefinic hydrocarbons, aromatic hydrocarbons, and oxygenated hydrocarbons. Conveniently, the gasoline may comprise a mixture of saturated hydrocarbons, olefinic hydrocarbons, aromatic hydrocarbons, and, optionally, oxygenated hydrocarbons.

Typically, the olefinic hydrocarbon content of the gasoline is in the range of from 0 to 40 percent by volume based on the gasoline (ASTM D1319); preferably, the olefinic hydrocarbon content of the gasoline is in the range of from 0 to 30 percent by volume based on the gasoline, more preferably, the olefinic hydrocarbon content of the gasoline is in the range of from 0 to 20 percent by volume based on the gasoline.

Typically, the aromatic hydrocarbon content of the gasoline is in the range of from 0 to 70 percent by volume based on the gasoline (ASTM D1319), for instance the aromatic hydrocarbon content of the gasoline is in the range of from 10 to 60 percent by volume based on the gasoline; preferably, the aromatic hydrocarbon content of the gasoline is in the range of from 0 to 50 percent by volume based on the gasoline, for instance the aromatic hydrocarbon content of the gasoline is in the range of from 10 to 50 percent by volume based on the gasoline.

The benzene content of the gasoline is at most 10 percent by volume, more preferably at most 5 percent by volume, especially at most 1 percent by volume based on the gasoline.

The gasoline preferably has a low or ultra low sulphur content, for instance at most 1000 ppmw (parts per million by weight), preferably no more than 500 ppmw, more preferably no more than 100, even more preferably no more than 50 and most preferably no more than even 10 ppmw.

The gasoline also preferably has a low total lead content, such as at most 0.005 g/l, most preferably being lead free—having no lead compounds added thereto (i.e. unleaded).

When the gasoline comprises oxygenated hydrocarbons, at least a portion of non-oxygenated hydrocarbons will be substituted for oxygenated hydrocarbons. The oxygen content of the gasoline may be up to 35 percent by weight (EN 1601) (e.g. ethanol per se) based on the gasoline. For example, the oxygen content of the gasoline may be up to 25 percent by weight, preferably up to 10 percent by weight. Conveniently, the oxygenate concentration will have a minimum concentration selected from any one of 0, 0.2, 0.4, 0.6, 0.8, 1.0, and 1.2 percent by weight, and a maximum concentration selected from any one of 5, 4.5, 4.0, 3.5, 3.0, and 2.7 percent by weight.

Examples of oxygenated hydrocarbons that may be incorporated into the gasoline include alcohols, ethers, esters, ketones, aldehydes, carboxylic acids and their derivatives, and oxygen containing heterocyclic compounds. Preferably, the oxygenated hydrocarbons that may be incorporated into the gasoline are selected from alcohols (such as methanol, ethanol, propanol, 2-propanol, butanol, tert-butanol, iso-butanol and 2-butanol), ethers (preferably ethers containing 5 or more carbon atoms per molecule, e.g., methyl tert-butyl ether and ethyl tert-butyl ether) and esters (preferably esters containing 5 or more carbon atoms per molecule); a particularly preferred oxygenated hydrocarbon is ethanol.

When oxygenated hydrocarbons are present in the gasoline, the amount of oxygenated hydrocarbons in the gasoline may vary over a wide range. For example, gasolines comprising a major proportion of oxygenated hydrocarbons are currently commercially available in countries such as Brazil and U.S.A., e.g. ethanol per se and E85, as well as gasolines comprising a minor proportion of oxygenated hydrocarbons, e.g. E10 and E5. Therefore, the gasoline may contain up to 100 percent by volume oxygenated hydrocarbons. E100 fuels as used in Brazil are also included herein. Preferably, the amount of oxygenated hydrocarbons present in the gasoline is selected from one of the following amounts: up to 85 percent by volume; up to 70 percent by volume; up to 65 percent by volume; up to 30 percent by volume; up to 20 percent by volume; up to 15 percent by volume; and, up to 10 percent by volume, depending upon the desired final formulation of the gasoline. Conveniently, the gasoline may contain at least 0.5, 1.0 or 2.0 percent by volume oxygenated hydrocarbons.

Examples of suitable gasolines include gasolines which have an olefinic hydrocarbon content of from 0 to 20 percent by volume (ASTM D1319), an oxygen content of from 0 to 5 percent by weight (EN 1601), an aromatic hydrocarbon content of from 0 to 50 percent by volume (ASTM D1319) and a benzene content of at most 1 percent by volume.

Also suitable for use herein are gasoline blending components which can be derived from a biological source. Examples of such gasoline blending components can be found in WO2009/077606, WO2010/028206, WO2010/000761, European patent application nos. 09160983.4, 09176879.6, 09180904.6, and U.S. patent application Ser. No. 61/312,307.

Whilst not critical to the present invention, the base gasoline or the gasoline composition of the present invention may conveniently include one or more optional fuel additives, in addition to the essential fuel additive mentioned above. The concentration and nature of the optional fuel additive(s) that may be included in the base gasoline or the gasoline composition of the present invention is not critical. Non-limiting examples of suitable types of fuel additives that can be included in the base gasoline or the gasoline composition of the present invention include anti-oxidants, corrosion inhibitors, detergents, dehazers, antiknock additives, metal deactivators, valve-seat recession protectant compounds, dyes, solvents, carrier fluids, diluents and markers. Examples of suitable such additives are described generally in U.S. Pat. No. 5,855,629.

Conveniently, the fuel additives can be blended with one or more solvents to form an additive concentrate, the additive concentrate can then be admixed with the base gasoline or the gasoline composition of the present invention.

The (active matter) concentration of any optional additives present in the base gasoline or the gasoline composition of the present invention is preferably up to 1 percent by weight, more preferably in the range from 5 to 2000 ppmw, advantageously in the range of from 300 to 1500 ppmw, such as from 300 to 1000 ppmw.

As stated above, the gasoline composition may also contain synthetic or mineral carrier oils and/or solvents.

Examples of suitable mineral carrier oils are fractions obtained in crude oil processing, such as brightstock or base oils having viscosities, for example, from the SN 500-2000 class; and also aromatic hydrocarbons, paraffinic hydrocarbons and alkoxyalkanols. Also useful as a mineral carrier oil is a fraction which is obtained in the refining of mineral oil and is known as “hydrocrack oil” (vacuum distillate cut having a boiling range of from about 360 to 500° C., obtainable from natural mineral oil which has been catalytically hydrogenated under high pressure and isomerized and also deparaffinized).

Examples of suitable synthetic carrier oils are: polyolefins (poly-alpha-olefins or poly(internal olefin)s), (poly)esters, (poly)alkoxylates, polyethers, aliphatic polyether amines, alkylphenol-started polyethers, alkylphenol-started polyether amines and carboxylic esters of long-chain alkanols.

Examples of suitable polyolefins are olefin polymers, in particular based on polybutene or polyisobutene (hydrogenated or nonhydrogenated).

Examples of suitable polyethers or polyetheramines are preferably compounds comprising polyoxy-C₂-C₄-alkylene moieties which are obtainable by reacting C₂-C₆₀-alkanols, C₆-C₃₀-alkanediols, mono- or di-C₂-C₃₀-alkylamines, C₁-C₃₀-alkylcyclohexanols or C₁-C₃₀-alkylphenols with from 1 to 30 mol of ethylene oxide and/or propylene oxide and/or butylene oxide per hydroxyl group or amino group, and, in the case of the polyether amines, by subsequent reductive amination with ammonia, monoamines or polyamines. Such products are described in particular in EP-A-310 875, EP-A-356 725, EP-A-700 985 and U.S. Pat. No. 4,877,416. For example, the polyether amines used may be poly-C₂-C₆-alkylene oxide amines or functional derivatives thereof. Typical examples thereof are tridecanol butoxylates or isotridecanol butoxylates, isononylphenol butoxylates and also polyisobutenol butoxylates and propoxylates, and also the corresponding reaction products with ammonia.

Examples of carboxylic esters of long-chain alkanols are in particular esters of mono-, di- or tricarboxylic acids with long-chain alkanols or polyols, as described in particular in DE-A-38 38 918. The mono-, di- or tricarboxylic acids used may be aliphatic or aromatic acids; suitable ester alcohols or polyols are in particular long-chain representatives having, for example, from 6 to 24 carbon atoms. Typical representatives of the esters are adipates, phthalates, isophthalates, terephthalates and trimellitates of isooctanol, isononanol, isodecanol and isotridecanol, for example di-(n- or isotridecyl) phthalate.

Further suitable carrier oil systems are described, for example, in DE-A-38 26 608, DE-A-41 42 241, DE-A-43 09 074, EP-A-0 452 328 and EP-A-0 548 617, which are incorporated herein by way of reference.

Examples of particularly suitable synthetic carrier oils are alcohol-started polyethers having from about 5 to 35, for example from about 5 to 30, C₃-C₆-alkylene oxide units, for example selected from propylene oxide, n-butylene oxide and isobutylene oxide units, or mixtures thereof. Non-limiting examples of suitable starter alcohols are long-chain alkanols or phenols substituted by long-chain alkyl in which the long-chain alkyl radical is in particular a straight-chain or branched C₆-C₁₈-alkyl radical. Preferred examples include tridecanol and nonylphenol.

Further suitable synthetic carrier oils are alkoxylated alkylphenols, as described in DE-A-10 102 913.6.

Mixtures of mineral carrier oils, synthetic carrier oils, and mineral and synthetic carrier oils may also be used.

Any solvent and optionally co-solvent suitable for use in fuels may be used. Examples of suitable solvents for use in fuels include: non-polar hydrocarbon solvents such as kerosene, heavy aromatic solvent (“solvent naphtha heavy”, “Solvesso 150”), toluene, xylene, paraffins, petroleum, white spirits, those sold by Shell companies under the trademark “SHELLSOL”, and the like. Examples of suitable co-solvents include: polar solvents such as esters and, in particular, alcohols (e.g. t-butanol, i-butanol, hexanol, 2-ethylhexanol, 2-propyl heptanol, decanol, isotridecanol, butyl glycols, and alcohol mixtures such as those sold by Shell companies under the trade mark “LINEVOL”, especially LINEVOL 79 alcohol which is a mixture of C₇₋₉ primary alcohols, or a C₁₂₋₁₄ alcohol mixture which is commercially available).

Dehazers/demulsifiers suitable for use in liquid fuels are well known in the art. Non-limiting examples include glycol oxyalkylate polyol blends (such as sold under the trade designation TOLAD™ 9312), alkoxylated phenol formaldehyde polymers, phenol/formaldehyde or C₁₋₁₈ alkylphenol/-formaldehyde resin oxyalkylates modified by oxyalkylation with C₁₋₁₈ epoxides and diepoxides (such as sold under the trade designation TOLAD™ 9308), and C₁₋₄ epoxide copolymers cross-linked with diepoxides, diacids, diesters, diols, diacrylates, dimethacrylates or diisocyanates, and blends thereof. The glycol oxyalkylate polyol blends may be polyols oxyalkylated with C₁₋₄ epoxides. The C₁₋₁₈ alkylphenol phenol/-formaldehyde resin oxyalkylates modified by oxyalkylation with C₁₋₁₈ epoxides and diepoxides may be based on, for example, cresol, t-butyl phenol, dodecyl phenol or dinonyl phenol, or a mixture of phenols (such as a mixture of t-butyl phenol and nonyl phenol). The dehazer should be used in an amount sufficient to inhibit the hazing that might otherwise occur when the gasoline without the dehazer contacts water, and this amount will be referred to herein as a “haze-inhibiting amount.” Generally, this amount is from about 0.1 to about 20 ppmw (e.g. from about 0.1 to about 10 ppm), more preferably from 1 to 15 ppmw, still more preferably from 1 to 10 ppmw, advantageously from 1 to 5 ppmw based on the weight of the gasoline.

Further customary additives for use in gasolines are corrosion inhibitors, for example based on ammonium salts of organic carboxylic acids, said salts tending to form films, or of heterocyclic aromatics for nonferrous metal corrosion protection; antioxidants or stabilizers, for example based on amines such as phenyldiamines, e.g. p-phenylenediamine, N,N′-di-sec-butyl-p-phenyldiamine, dicyclohexylamine or derivatives thereof or of phenols such as 2,4-di-tert-butylphenol or 3,5-di-tert-butyl-4-hydroxy-phenylpropionic acid; anti-static agents; metallocenes such as ferrocene; methylcyclopentadienylmanganese tricarbonyl; lubricity additives, such as certain fatty acids, alkenylsuccinic esters, bis(hydroxyalkyl) fatty amines, hydroxyacetamides or castor oil; and also dyes (markers). Amines may also be added, if appropriate, for example as described in WO 03/076554. Optionally anti valve seat recession additives may be used such as sodium or potassium salts of polymeric organic acids.

The gasoline compositions herein can also comprise a detergent additive. Suitable detergent additives include those disclosed in WO2009/50287, incorporated herein by reference.

Preferred detergent additives for use in the gasoline composition herein typically have at least one hydrophobic hydrocarbon radical having a number-average molecular weight (Mn) of from 85 to 20 000 and at least one polar moiety selected from:

(A1) mono- or polyamino groups having up to 6 nitrogen atoms, of which at least one nitrogen atom has basic properties;

(A6) polyoxy-C₂— to —C₄-alkylene groups which are terminated by hydroxyl groups, mono- or polyamino groups, in which at least one nitrogen atom has basic properties, or by carbamate groups;

(A8) moieties derived from succinic anhydride and having hydroxyl and/or amino and/or amido and/or imido groups; and/or

(A9) moieties obtained by Mannich reaction of substituted phenols with aldehydes and mono- or polyamines.

The hydrophobic hydrocarbon radical in the above detergent additives, which ensures the adequate solubility in the base fluid, has a number-average molecular weight (Mn) of from 85 to 20 000, especially from 113 to 10 000, in particular from 300 to 5000. Typical hydrophobic hydrocarbon radicals, especially in conjunction with the polar moieties (A1), (A8) and (A9), include polyalkenes (polyolefins), such as the polypropenyl, polybutenyl and polyisobutenyl radicals each having Mn of from 300 to 5000, preferably from 500 to 2500, more preferably from 700 to 2300, and especially from 700 to 1000.

Non-limiting examples of the above groups of detergent additives include the following:

Additives comprising mono- or polyamino groups (A1) are preferably polyalkenemono- or polyalkenepolyamines based on polypropene or conventional (i.e. having predominantly internal double bonds) polybutene or polyisobutene having Mn of from 300 to 5000. When polybutene or polyisobutene having predominantly internal double bonds (usually in the beta and gamma position) are used as starting materials in the preparation of the additives, a possible preparative route is by chlorination and subsequent amination or by oxidation of the double bond with air or ozone to give the carbonyl or carboxyl compound and subsequent amination under reductive (hydrogenating) conditions. The amines used here for the amination may be, for example, ammonia, monoamines or polyamines, such as dimethylaminopropylamine, ethylenediamine, diethylenetriamine, triethylenetetramine or tetraethylenepentamine. Corresponding additives based on polypropene are described in particular in WO-A-94/24231.

Further preferred additives comprising monoamino groups (A1) are the hydrogenation products of the reaction products of polyisobutenes having an average degree of polymerization of from 5 to 100, with nitrogen oxides or mixtures of nitrogen oxides and oxygen, as described in particular in WO-A-97/03946.

Further preferred additives comprising monoamino groups (A1) are the compounds obtainable from polyisobutene epoxides by reaction with amines and subsequent dehydration and reduction of the amino alcohols, as described in particular in DE-A-196 20 262.

Additives comprising polyoxy-C₂-C₄-alkylene moieties (A6) are preferably polyethers or polyetheramines which are obtainable by reaction of C₂- to C₆₀-alkanols, C₆- to C₃₀-alkanediols, mono- or di-C₂-C₃₀-alkylamines, C₁-C₃₀-alkylcyclohexanols or C₁-C₃₀-alkylphenols with from 1 to 30 mol of ethylene oxide and/or propylene oxide and/or butylene oxide per hydroxyl group or amino group and, in the case of the polyether-amines, by subsequent reductive amination with ammonia, monoamines or polyamines. Such products are described in particular in EP-A-310 875, EP-A-356 725, EP-A-700 985 and US-A-4 877 416. In the case of polyethers, such products also have carrier oil properties. Typical examples of these are tridecanol butoxylates, isotridecanol butoxylates, isononylphenol butoxylates and polyisobutenol butoxylates and propoxylates and also the corresponding reaction products with ammonia.

Additives comprising moieties derived from succinic anhydride and having hydroxyl and/or amino and/or amido and/or imido groups (A8) are preferably corresponding derivatives of polyisobutenylsuccinic anhydride which are obtainable by reacting conventional or highly reactive polyisobutene having Mn of from 300 to 5000 with maleic anhydride by a thermal route or via the chlorinated polyisobutene. Of particular interest are derivatives with aliphatic polyamines such as ethylenediamine, diethylenetriamine, triethylenetetramine or tetraethylenepentamine. Such additives are described in particular in U.S. Pat. No. 4,849,572.

Additives comprising moieties obtained by Mannich reaction of substituted phenols with aldehydes and mono- or polyamines (A9) are preferably reaction products of polyisobutene-substituted phenols with formaldehyde and mono- or polyamines such as ethylenediamine, diethylenetriamine, triethylenetetramine, tetraethylenepentamine or dimethylaminopropylamine. The polyisobutenyl-substituted phenols may stem from conventional or highly reactive polyisobutene having Mn of from 300 to 5000. Such “polyisobutene-Mannich bases” are described in particular in EP-A-831 141.

Preferably, the detergent additive used in the gasoline compositions of the present invention contains at least one nitrogen-containing detergent, more preferably at least one nitrogen-containing detergent containing a hydrophobic hydrocarbon radical having a number average molecular weight in the range of from 300 to 5000. Preferably, the nitrogen-containing detergent is selected from a group comprising polyalkene monoamines, polyetheramines, polyalkene Mannich amines and polyalkene succinimides. Conveniently, the nitrogen-containing detergent may be a polyalkene monoamine.

In the liquid fuel compositions of the present invention, if the base fuel used is a diesel fuel, then the diesel fuel used as the base fuel in the present invention includes diesel fuels for use in automotive compression ignition engines, as well as in other types of engine such as for example off road, marine, railroad and stationary engines. The diesel fuel used as the base fuel in the liquid fuel composition of the present invention may conveniently also be referred to as ‘diesel base fuel’.

The diesel base fuel may itself comprise a mixture of two or more different diesel fuel components, and/or be additivated as described below.

Such diesel fuels will contain one or more base fuels which may typically comprise liquid hydrocarbon middle distillate gas oil(s), for instance petroleum derived gas oils. Such fuels will typically have boiling points within the usual diesel range of 150 to 400° C., depending on grade and use. They will typically have a density from 750 to 1000 kg/m³, preferably from 780 to 860 kg/m³, at 15° C. (e.g. ASTM D4502 or IP 365) and a cetane number (ASTM D613) of from 35 to 120, more preferably from 40 to 85. They will typically have an initial boiling point in the range 150 to 230° C. and a final boiling point in the range 290 to 400° C. Their kinematic viscosity at 40° C. (ASTM D445) might suitably be from 1.2 to 4.5 mm²/s.

An example of a petroleum derived gas oil is a Swedish Class 1 base fuel, which will have a density from 800 to 820 kg/m³ at 15° C. (SS-EN ISO 3675, SS-EN ISO 12185), a T95 of 320° C. or less (SS-EN ISO 3405) and a kinematic viscosity at 40° C. (SS-EN ISO 3104) from 1.4 to 4.0 mm²/s, as defined by the Swedish national specification EC1.

Optionally, non-mineral oil based fuels, such as biofuels or Fischer-Tropsch derived fuels, may also form or be present in the diesel fuel. Such Fischer-Tropsch fuels may for example be derived from natural gas, natural gas liquids, petroleum or shale oil, petroleum or shale oil processing residues, coal or biomass.

The amount of Fischer-Tropsch derived fuel used in the diesel fuel may be from 0% to 100% v of the overall diesel fuel, preferably from 5% to 100% v, more preferably from 5% to 75% v. It may be desirable for such a diesel fuel to contain 10% v or greater, more preferably 20% v or greater, still more preferably 30% v or greater, of the Fischer-Tropsch derived fuel. It is particularly preferred for such diesel fuels to contain 30 to 75% v, and particularly 30 to 70% v, of the Fischer-Tropsch derived fuel. The balance of the diesel fuel is made up of one or more other diesel fuel components.

Such a Fischer-Tropsch derived fuel component is any fraction of the middle distillate fuel range, which can be isolated from the (optionally hydrocracked) Fischer-Tropsch synthesis product. Typical fractions will boil in the naphtha, kerosene or gas oil range. Preferably, a Fischer-Tropsch product boiling in the kerosene or gas oil range is used because these products are easier to handle in for example domestic environments. Such products will suitably comprise a fraction larger than 90 wt % which boils between 160 and 400° C., preferably to about 370° C. Examples of Fischer-Tropsch derived kerosene and gas oils are described in EP-A-0583836, WO-A-97/14768, WO-A-97/14769, WO-A-00/11116, WO-A-00/11117, WO-A-01/83406, WO-A-01/83648, WO-A-01/83647, WO-A-01/83641, WO-A-00/20535, WO-A-00/20534, EP-A-1101813, U.S. Pat. No. 5,766,274, U.S. Pat. No. 5,378,348, U.S. Pat. No. 5,888,376 and U.S. Pat. No. 6,204,426.

The Fischer-Tropsch product will suitably contain more than 80 wt % and more suitably more than 95 wt % iso and normal paraffins and less than 1 wt % aromatics, the balance being naphthenics compounds. The content of sulphur and nitrogen will be very low and normally below the detection limits for such compounds. For this reason the sulphur content of a diesel fuel composition containing a Fischer-Tropsch product may be very low.

The diesel fuel composition preferably contains no more than 5000 ppmw sulphur, more preferably no more than 500 ppmw, or no more than 350 ppmw, or no more than 150 ppmw, or no more than 100 ppmw, or no more than 70 ppmw, or no more than 50 ppmw, or no more than 30 ppmw, or no more than 20 ppmw, or most preferably no more than 10 ppmw sulphur.

Other diesel fuel components for use herein include the so-called “biofuels” which derive from biological materials. Examples include fatty acid alkyl esters (FAAE). Examples of such components can be found in WO2008/135602.

The diesel base fuel may itself be additivated (additive-containing) or unadditivated (additive-free). If additivated, e.g. at the refinery, it will contain minor amounts of one or more additives selected for example from anti-static agents, pipeline drag reducers, flow improvers (e.g. ethylene/vinyl acetate copolymers or acrylate/maleic anhydride copolymers), lubricity additives, antioxidants and wax anti-settling agents.

Detergent-containing diesel fuel additives are known and commercially available. Such additives may be added to diesel fuels at levels intended to reduce, remove, or slow the build-up of engine deposits.

Examples of detergents suitable for use in diesel fuel additives for the present purpose include polyolefin substituted succinimides or succinamides of polyamines, for instance polyisobutylene succinimides or polyisobutylene amine succinamides, aliphatic amines, Mannich bases or amines and polyolefin (e.g. polyisobutylene) maleic anhydrides. Succinimide dispersant additives are described for example in GB-A-960493, EP-A-0147240, EP-A-0482253, EP-A-0613938, EP-A-0557516 and WO-A-98/42808. Particularly preferred are polyolefin substituted succinimides such as polyisobutylene succinimides.

The diesel fuel additive mixture may contain other components in addition to the detergent. Examples are lubricity enhancers; dehazers, e.g. alkoxylated phenol formaldehyde polymers; anti-foaming agents (e.g. polyether-modified polysiloxanes); ignition improvers (cetane improvers) (e.g. 2-ethylhexyl nitrate (EHN), cyclohexyl nitrate, di-tert-butyl peroxide and those disclosed in U.S. Pat. No. 4,208,190 at column 2, line 27 to column 3, line 21); anti-rust agents (e.g. a propane-1,2-diol semi-ester of tetrapropenyl succinic acid, or polyhydric alcohol esters of a succinic acid derivative, the succinic acid derivative having on at least one of its alpha-carbon atoms an unsubstituted or substituted aliphatic hydrocarbon group containing from 20 to 500 carbon atoms, e.g. the pentaerythritol diester of polyisobutylene-substituted succinic acid); corrosion inhibitors; reodorants; anti-wear additives; anti-oxidants (e.g. phenolics such as 2,6-di-tert-butylphenol, or phenylenediamines such as N,N′-di-sec-butyl-p-phenylenediamine); metal deactivators; combustion improvers; static dissipator additives; cold flow improvers; and wax anti-settling agents.

The diesel fuel additive mixture may contain a lubricity enhancer, especially when the diesel fuel composition has a low (e.g. 500 ppmw or less) sulphur content. In the additivated diesel fuel composition, the lubricity enhancer is conveniently present at a concentration of less than 1000 ppmw, preferably between 50 and 1000 ppmw, more preferably between 70 and 1000 ppmw. Suitable commercially available lubricity enhancers include ester- and acid-based additives. Other lubricity enhancers are described in the patent literature, in particular in connection with their use in low sulphur content diesel fuels, for example in:
the paper by Danping Wei and H. A. Spikes, “The Lubricity of Diesel Fuels”, Wear, III (1986) 217-235;
WO-A-95/33805—cold flow improvers to enhance lubricity of low sulphur fuels;
U.S. Pat. No. 5,490,864—certain dithiophosphoric diester-dialcohols as anti-wear lubricity additives for low sulphur diesel fuels; and
WO-A-98/01516—certain alkyl aromatic compounds having at least one carboxyl group attached to their aromatic nuclei, to confer anti-wear lubricity effects particularly in low sulphur diesel fuels.

It may also be preferred for the diesel fuel composition to contain an anti-foaming agent, more preferably in combination with an anti-rust agent and/or a corrosion inhibitor and/or a lubricity enhancing additive.

Unless otherwise stated, the (active matter) concentration of each such optional additive component in the additivated diesel fuel composition is preferably up to 10000 ppmw, more preferably in the range from 0.1 to 1000 ppmw, advantageously from 0.1 to 300 ppmw, such as from 0.1 to 150 ppmw.

The (active matter) concentration of any dehazer in the diesel fuel composition will preferably be in the range from 0.1 to 20 ppmw, more preferably from 1 to 15 ppmw, still more preferably from 1 to 10 ppmw, and especially from 1 to 5 ppmw. The (active matter) concentration of any ignition improver present will preferably be 2600 ppmw or less, more preferably 2000 ppmw or less, even more preferably 300 to 1500 ppmw. The (active matter) concentration of any detergent in the diesel fuel composition will preferably be in the range from 5 to 1500 ppmw, more preferably from 10 to 750 ppmw, most preferably from 20 to 500 ppmw.

In the case of a diesel fuel composition, for example, the fuel additive mixture will typically contain a detergent, optionally together with other components as described above, and a diesel fuel-compatible diluent, which may be a mineral oil, a solvent such as those sold by Shell companies under the trade mark “SHELLSOL”, a polar solvent such as an ester and, in particular, an alcohol, e.g. hexanol, 2-ethylhexanol, decanol, isotridecanol and alcohol mixtures such as those sold by Shell companies under the trade mark “LINEVOL”, especially LINEVOL 79 alcohol which is a mixture of C₇₋₉ primary alcohols, or a C₁₂₋₁₄ alcohol mixture which is commercially available.

The total content of the additives in the diesel fuel composition may be suitably between 0 and 10000 ppmw and preferably below 5000 ppmw.

In the above, amounts (concentrations, % vol, ppmw, % wt) of components are of active matter, i.e. exclusive of volatile solvents/diluent materials.

The liquid fuel composition of the present invention is produced by admixing the at least one essential fuel additive with a base fuel suitable for use in an internal combustion engine. If the base fuel to which the essential fuel additive is admixed is a gasoline, then the liquid fuel composition produced is a gasoline composition; likewise, if the base fuel to which the fuel additive is admixed is a diesel fuel, then the liquid fuel composition produced is a diesel fuel composition.

It has surprisingly been found that the use of a fuel additive having a kinematic viscosity at 100° C. of 27 cSt or less and a NOACK volatility at 250° C. of 100% wt, preferably 20 wt % or less, and a friction modifier in liquid fuel compositions provides benefits in terms of improved fuel economy of an internal combustion engine being fuelled by the liquid fuel composition containing said additive, in particular when the liquid fuel composition of the present invention is a gasoline composition, relative to the internal combustion engine being fuelled by the liquid base fuel.

The present invention therefore provides a method of improving the fuel economy performance of a liquid base fuel suitable for use in an internal combustion engine, comprising admixing at least one fuel additive having a kinematic viscosity at 100° C. of 27 cSt or less and a NOACK volatility at 250° C. of 100% wt, preferably 20 wt % or less, and at least one friction modifier with a major portion of a liquid base fuel suitable for use in an internal combustion engine.

Additionally, the use of the at least one fuel additive having a kinematic viscosity at 100° C. of 27 cSt or less and a NOACK volatility at 250° C. of 100% wt, preferably 20 wt % or less, in combination with a friction modifier in liquid fuel compositions can also provide benefits in terms improving the lubricant performance of an internal combustion engine being fuelled by the liquid fuel composition of the present invention relative to the internal combustion engine being fuelled by the liquid base fuel.

Therefore, the present invention also provides a method of improving the performance of the lubricant of an internal combustion engine, said method comprising fuelling an internal combustion engine containing the engine lubricant with a liquid fuel composition according to the present invention.

Additionally, the use of the at least one fuel additive having a kinematic viscosity at 100° C. of 27 cSt or less and a NOACK volatility at 250° C. of 100% wt, preferably 20 wt % or less, and at least one friction modifier in liquid fuel compositions can also provide benefits in terms of improving the fuel economy performance of a lubricant of an internal combustion engine being fuelled by the liquid fuel composition of the present invention.

Therefore, the present invention provides a method of improving the fuel economy performance of a lubricant of an internal combustion engine, said method comprising fuelling the internal combustion engine containing the lubricant with a liquid fuel composition comprising:
a base fuel suitable for use in an internal combustion engine; and
at least one fuel additive having:
(i) a kinematic viscosity at 100° C. of 27 cSt or less; and
(ii) a NOACK volatility at 250° C. of 100% wt, preferably 20% wt or less; and
   at least one friction modifier.

### Lubricating Oil

Lubricating oil compositions according to the present invention contain a lubricating oil as the base fluid, and are suitable for use as an engine crank case lubricant.

The total amount of lubricating oil incorporated in the lubricating oil composition is at least 60 percent by weight, preferably in the range of from 60 to 92 percent by weight, more preferably in the range of from 75 to 90 percent by weight and most preferably in the range of from 75 to 88 percent by weight, with respect to the total weight of the lubricating oil composition.

There are no particular limitations regarding the lubricating oil used in the lubricating oil composition, and various conventional known mineral oils and synthetic oils may be conveniently used.

The lubricating oil used in the lubricating oil composition may conveniently comprise mixtures of one or more mineral oils and/or one or more synthetic oils.

Mineral oils include liquid petroleum oils and solvent-treated or acid-treated mineral lubricating oil of the paraffinic, naphthenic, or mixed paraffinic/naphthenic type which may be further refined by hydrofinishing processes and/or dewaxing.

Naphthenic lubricating oils have low viscosity index (VI) (generally 40-80) and a low pour point. Such lubricating oils are produced from feedstocks rich in naphthenes and low in wax content and are used mainly for lubricants in which colour and colour stability are important, and VI and oxidation stability are of secondary importance.

Paraffinic lubricating oils have higher VI (generally >95) and a high pour point. Said lubricating oils are produced from feedstocks rich in paraffins, and are used for lubricants in which VI and oxidation stability are important.

Fischer-Tropsch derived lubricating oils may be conveniently used in the lubricating oil composition, for example, the Fischer-Tropsch derived lubricating oils disclosed in EP-A-776959, EP-A-668342, WO-A-97/21788, WO-00/15736, WO-00/14188, WO-00/14187, WO-00/14183, WO-00/14179, WO-00/08115, WO-99/41332, EP-1029029, WO-01/18156 and WO-01/57166.

Synthetic processes enable molecules to be built from simpler substances or to have their structures modified to give the precise properties required.

Synthetic lubricating oils include hydrocarbon oils such as olefin oligomers (PAOs), dibasic acids esters, polyol esters, and dewaxed waxy raffinate. Synthetic hydrocarbon base oils sold by the Royal Dutch/Shell Group of Companies under the designation “XHVI” (trade mark) may be conveniently used.

Preferably, the lubricating oil is constituted from mineral oils and/or synthetic oils which contain more than 80% wt of saturates, preferably more than 90 percent by weight, as measured according to ASTM D2007.

It is further preferred that the lubricating oil contains less than 1.0 percent by weight, preferably less than 0.1 percent by weight of sulphur, calculated as elemental sulphur and measured according to ASTM D2622, ASTM D4294, ASTM D4927 or ASTM D3120.

Preferably, the viscosity index of the lubricating oil, is more than 80, more preferably more than 120, as measured according to ASTM D2270.

Preferably, the lubricating oil has a kinematic viscosity in the range of from 2 to 80 mm²/s at 100° C., more preferably in the range of from 3 to 70 mm²/s, most preferably in the range of from 4 to 50 mm²/s.

The total amount of phosphorus in the lubricating oil is preferably in the range of from 0.04 to 0.1 percent by weight, more preferably in the range of from 0.04 to 0.09 percent by weight and most preferably in the range of from 0.045 to 0.09 percent by weight, based on total weight of the lubricating oil.

The lubricating oil preferably has a sulphated ash content of not greater than 1.0 percent by weight, more preferably not greater than 0.75 percent by weight and most preferably not greater than 0.7 percent by weight, based on the total weight of the lubricating oil.

The lubricating oil composition preferably has a sulphur content of not greater than 1.2 percent by weight, more preferably not greater than 0.8 percent by weight and most preferably not greater than 0.2 percent by weight, based on the total weight of the lubricating oil lubricating oil composition.

The lubricating oil composition may further comprise additives such as anti-oxidants, anti-wear additives, detergents, dispersants, friction modifiers, viscosity index improvers, pour point depressants, corrosion inhibitors, defoaming agents and seal fix or seal compatibility agents.

Antioxidants that may be conveniently used include those selected from the group of aminic antioxidants and/or phenolic antioxidants.

In a preferred embodiment, said antioxidants are present in an amount in the range of from 0.1 to 5.0 percent by weight, more preferably in an amount in the range of from 0.3 to 3.0 percent by weight, and most preferably in an amount of in the range of from 0.5 to 1.5 percent by weight, based on the total weight of the lubricating oil composition.

The lubricating oil composition may conveniently contain a single zinc dithiophosphate or a combination of two or more zinc dithiophosphates as anti-wear additives, the or each zinc dithiophosphate being selected from zinc dialkyl-, diaryl- or alkylaryl-dithiophosphates.

The lubricating oil composition may generally contain in the range of from 0.4 to 1.0 percent by weight of zinc dithiophosphate, based on total weight of the lubricating oil composition.

Additional or alternative anti-wear additives may be conveniently used in the lubricating oil composition of the present invention.

Suitable alternative anti-wear additives include boron-containing compounds such as borate esters, borated fatty amines, borated epoxides, alkali metal (or mixed alkali or alkaline earth metal) borates and borated overbased metal salts. Said boron-containing anti-wear additives may be conveniently added to the lubricating oil in an amount in the range of from 0.1 to 3.0 percent by weight, based on the total weight of lubricating oil composition.

Typical detergents that may be used in the lubricating oil composition include one or more salicylate and/or phenate and/or sulphonate detergents.

However, as metal organic and inorganic base salts which are used as detergents can contribute to the sulphated ash content of a lubricating oil composition, in a preferred embodiment of the present invention, the amounts of such additives are minimised.

Furthermore, in order to maintain a low sulphur level, salicylate detergents are preferred.

Thus, in a preferred embodiment, the lubricating oil composition may contain one or more salicylate detergents.

In order to maintain the total sulphated ash content of the lubricating oil composition at a level of preferably not greater than 1.0 percent by weight, more preferably at a level of not greater than 0.75 percent by weight and most preferably at a level of not greater than 0.7 percent by weight, based on the total weight of the lubricating oil composition, said detergents are preferably used in amounts in the range of 0.05 to 12.5 percent by weight, more preferably from 1.0 to 9.0 percent by weight and most preferably in the range of from 2.0 to 5.0 percent by weight, based on the total weight of the lubricating oil composition.

Furthermore, it is preferred that said detergents, independently, have a TBN (total base number) value in the range of from 10 to 500 mg·KOH/g, more preferably in the range of from 30 to 350 mg·KOH/g and most preferably in the range of from 50 to 300 mg·KOH/g, as measured by ISO 3771.

The lubricating oil compositions may additionally contain an ash-free dispersant which is preferably admixed in an amount in the range of from 5 to 15 percent by weight, based on the total weight of the lubricating oil composition. Examples of ash-free dispersants which may be used

include the polyalkenyl succinimides and polyalkenyl succininic acid esters disclosed in Japanese Patent Nos. 1367796, 1667140, 1302811 and 1743435. Preferred dispersants include borated succinimides.

Examples of viscosity index improvers which may conveniently used in the lubricating oil composition include the styrene-butadiene copolymers, styrene-isoprene stellate copolymers and the polymethacrylate copolymer and ethylene-propylene copolymers. Such viscosity index improvers may be conveniently employed in an amount in the range of from 1 to 20 percent by weight, based on the total weight of the lubricating oil composition.

Polymethacrylates may be conveniently employed in the lubricating oil compositions as effective pour point depressants.

Furthermore, compounds such as alkenyl succinic acid or ester moieties thereof, benzotriazole-based compounds and thidiazole-based compounds may be conveniently used in the lubricating oil composition as corrosion inhibitors.

Compounds such as polysiloxanes, dimethyl polycyclohexane and polyacrylates may be conveniently used in the lubricating oil composition as defoaming agents.

Compounds which may be conveniently used in the lubricating oil composition as seal fix or seal compatibility agents include, for example, commercially available aromatic esters.

The present invention will be further understood from the following examples. Unless otherwise stated, all amounts and concentrations disclosed in the examples are based on weight of the fully formulated fuel composition.

### EXAMPLES

### Example 1

In the following example, three commercially available friction modifiers (FM) were used:

FM10—this is a reaction product of oleic acid and aminoethylethanolamine having a 3:1 molar ratio as per Example 4 of WO2009/50287.

FM11—this is the reaction products of C8-C18 fatty acids and C18 unsaturated fatty acids with diethanolamine and propylene oxide (as disclosed in WO2010/05720).

FM14—CH-5 commercially available from Sanzheng Polymer Company.

In the following example, a commercially available viscosity control agent (VCA) was used as follows:

VCA2—Synfluid PAO-5 commercially available from Chevron.

Table 1 shows the relative amounts (in wt %) of the various additives (detergent additive package, VCA, FM and solvent) present in each of the additive blends.

In some examples, a solvent eg Shellsol A150 commercially available from Shell and 2-ethylhexanol is also blended into the additive package to improve stability and handling of the additive package.

TABLE 1

| | 1 | 2 | 3 | 4 | 5 | 6 |
|---|---|---|---|---|---|---|
| Detergent | 46.0 | 85.5 | 42.4 | 74.1 | 85.5 | 74.1 |
| Additive | | | | | | |
| package | | | | | | |
| FM10 | 6.9 | 0 | 6.4 | 0 | 0 | 0 |
| FM11 | 0 | 12.8 | 0 | 11.1 | 0 | 0 |
| FM14 | 0 | 0 | 0 | 0 | 12.8 | 11.1 |
| VCA2 | 0.9 | 1.7 | 8.5 | 14.8 | 1.7 | 14.8 |
| Solvent | 46.2 | 0 | 42.7 | 0 | 0 | 0 |
| Total | 100 | 100 | 100 | 100 | 100 | 100 |
| Kv40¹ | 6.676 | 30.14 | 7.073 | 29.14 | n.d. | n.d. |
| Kv100² | 2.083 | 6.118 | 2.173 | 5.948 | n.d. | n.d. |

1. Kinematic Viscosity at 40° C. in mm²/s according to standard test method IP 71 (Energy Institute UK) which corresponds to ASTM D 445
2. Kinematic Viscosity at 100° C. in mm²/s according to standard test method IP 71 (Energy Institute UK) which corresponds to ASTM D 445
n.d.=not determined

The additive blends shown in Table 1 have improved handlability properties such as improved viscosity characteristics.

The additive blends from Table 1 are each blended into an EN228 gasoline fuel in an amount of 10 to 6000 ppmw, based on the total gasoline fuel composition.

The fuel compositions of the examples provide improved fuel economy benefits, good cleaniness and reduced friction by both hydrodynamic and boundary lubrication effects.

### Examples 2 to 5

The composition and properties of a number of commercially available components that can be used as first fuel additive and second fuel additive are given below. Certain of these components are used in Examples 2 to 5.

Durasyn 165, a PAO-5 commercially available from INEOS Oligomers.

Durasyn 162, a PAO-2 commercially available from INEOS Oligomers.

Priolube 3970, a C7-C9 ester of trimethylolpropane commercially available from Croda Europe Limited.

FM10—this is a reaction product of oleic acid and aminoethylethanolamine having a 3:1 molar ratio as per Example 4 of WO2009/50287.

Ethomeen T12e, an ethoxylated amine produced from tallowamine with an average 2 moles of ethyleneoxide, commercially available from AkzoNobel.

FM11—this is the reaction product of C8-C18 fatty acids and C18 unsaturated fatty acids with diethanolamine and propylene oxide (as disclosed in WO2010/05720).

| | | | KV | NOACK |
|---|---|---|---|---|
| | | | 100° C. | 250° C. |
| | | | ASTM | ASTM |
| | | | D445 | D5800 |
| Trade Name | Supplier | Chemistry | (cSt) | (% wt) |
| Durasyn 162 | INEOS | Poly Alpha | 2.1 | 99 |
| | Oligomers | Olefin 2 | | |
| Durasyn 164 | INEOS | Poly Alpha | 4.1 | 14 |
| | Oligomers | Olefin 4 | | |
| Durasyn 166 | INEOS | Poly Alpha | 6.1 | 9 |
| | Oligomers | Olefin 6 | | |
| Durasyn 168 | INEOS | Poly Alpha | 7.77 | 3.13 |
| | Oligomers | Olefin 8 | | |
| Synfluid PAO 5 | Chevron | Poly Alpha | 5.1 | 5.8 |
| | Corporation | Olefin 5 | | |
| Durasyn 165 | INEOS | Poly Alpha | 5.1 | 5.5 |
| | Oligomers | Olefin 5 | | |
| Durasyn 125 | INEOS | Poly Alpha | 5.1 | 5.5 |
| | Oligomers | Olefin 5 | | |
| Priolube 3970 | Croda | TMP Cocoate | 4.4 | 4.5 |
| | Europe | Ester | | |
| | Limited | | | |
| Priolube1858 | Croda | Diisodecyl | 4.5 | 7.2 |
| | Europe | Azelate | | |
| | Limited | Ester | | |
| Synative ES EHO | Cognis Gmbh | 2-Ethylhexyl | 2.8 | 20 |
| | | Oleate | | |
| | | Ester | | |
| Synative ES 3824 | Cognis Gmbh | Neopentyl | 2.5 | 7.6 |
| | | Glycol | | |
| | | Cocoate/C8- | | |
| | | 10 Ester | | |

### Example 2

Products 1-18 were tested using a modified HFRR (ISO 12156) method to allow testing in gasoline. The lubricity of the gasoline compositions was determined by using a modified HFRR test. The modified HFRR test is based on ISO 12156-1 using a PCS Instruments HFRR supplemented with the PCS Instruments Gasoline Conversion Kit, and using a fluid volume of 15.0 ml (+/−0.2 ml), a fluid temperature of 25.0° C. (+/−1° C.), and wherein a PTFE cover is used to cover the test sample in order to minimise evaporation.

The additives were tested at 200 mg/L in an unleaded gasoline meeting EN228 specifications, containing no ethanol (E0). Lower lubricity and friction coefficient results are indications of better friction modification effects and indicates better fuel economy. This is shown by Friction modifiers d to j in Table 2 below.

TABLE 2

| | | Lubricity | |
|---|---|---|---|
| | | result | Friction |
| | | (microns) | Coefficient |
| | Test molecule | average | average |
| Base Fuel | Unleaded gasoline | 872.5 | 0.641 |
| | ULG95, E0 | | |
| Detergent a | PIB Succinimide | 720 | 0.448 |
| (type A8) | detergent | | |
| Detergent b | Poly ether amine | 887 | 0.632 |
| (type A6 ) | detergent | | |
| Detergent c | PIBAmine | 871 | 0.812 |
| (type A1) | detergent | | |
| Friction | FM11 | 534.5 | 0.284 |
| modifier d | | | |
| Friction | Kerocom K3561 | 385.5 | 0.212 |
| modifier e | | | |
| Friction | FM10 | 401 | 0.246 |
| modifier f | | | |
| Friction | Ultrazol 9525 | 549.5 | 0.281 |
| modifier g | | | |
| Friction | Priolube 1407 | 308 | 0.196 |
| modifier h | | | |
| Friction | Ethomeen T12e | 481 | 0.287 |
| modifier i | | | |
| Friction | Ethomeen O15 | 697 | 0.344 |
| modifier j | | | |
| VCA k | PAO 2 (Durasyn | 879.5 | 0.683 |
| | 162) | | |
| VCA l | PAO 4 (Durasyn | 872.5 | 0.657 |
| | 164) | | |
| VCA m | PAO 5 (Synfluid | 880.5 | 0.729 |
| | PAO 5) | | |
| VCA n | PAO 8 (Durasyn | 870.5 | 0.668 |
| | 168) | | |
| VCA o | Priolube 3970 | 890 | 0.717 |
| VCA p | Synative ES 3824 | 869 | 0.636 |
| VCA q | Priolube1858 | 844 | 0.771 |
| VCA r | SYNATIVE ES EHO | 857 | 0.636 |

This example shows that molecules designed for detergent performance (a-c) do not show friction modification performance, and molecules designed for VCA performance (k-r) do not show friction modification performance.

### Example 3

3 vehicles of Five models (see Table 3) completed 10,000 miles of on-road mixed driving style mileage accumulation. The vehicles used standard ULG95, an ethanol-free base fuel that meets standard specification EN 228. In each case the base fuel was pre-treated with the same commercial detergent additive package, and each fuel additionally contained a test additive at a concentration detailed in Table 4.

TABLE 3

VW Golf 1.6 ltr S
Ford Mondeo 2.0 ltr Edge
Mitsubishi Lancer 1.8 ltr GS2
GM Zafira 1.6 16 v Active
Honda Civic 1.8 SE

TABLE 4
Test Fuel Composition

| | (Test) Fuel | (Test) Fuel | (Test) Fuel |
|---|---|---|---|
| Base Fuel | EN228 ULG95 | EN228 ULG95 | EN228 ULG95 |
| Lubricant | Shell Helix | Shell Helix | Shell Helix |
| | HX7 SAE 10W- | HX7 SAE 5W- | HX7 SAE 5W- |
| | 40 | 30 | 30 |
| Detergent | Commercial | Commercial | Commercial |
| Package | Package | Package | Package |
| Test Additives | PAO5 at | CH-2C at | CH-5 at |
| | 1000 ppmw | 200 ppmw | 200 ppmw |
| Average Test | 6.1% m/m | 1.6% m/m | 1.6% m/m |
| Additive | | | |
| concentration | | | |
| in lubricant | | | |
| after 10,000 | | | |
| miles | | | |
| Average fuel | 0.74% | 0.84% | 0.54% |
| economy (steady | | | |
| state) benefit | | | |
| across 5 models | | | |

Fuel consumption was measured at steady state conditions (32 km/h 2^{nd} gear). Duplicate emissions tests were carried out on each vehicle at 10,000 miles.

Test additive concentration in the lubricant after 10,000 miles was determined by either GC—gas chromatography (PAO5) or NMR (CH-2C and CH-5).

Friction modifiers CH-2C and CH-5 are commercially available from Shanghai Sanzheng Polymer Company.

PAO-5 is Synfluid PAO 5 commercially available from Chevron Philips.

### Example 4

Two fuels were tested to study additive transfer into a lubricant.

A test was run on a pair of Ford Focus ST-2 2.5 ltr cars with about 22,000 miles on the odometer. The lubricant used was Helix Ultra Extra 5W-30 commercially available from Shell Lubricants. The base fuel was an EN228 gasoline base fuel. The cars were run on additised fuel containing detergent package, friction modifier and viscosity control additive.

The lubricant was sampled at the start of test and end of a 12,000 mile accumulation on a high speed cycle chassis dynameter programme. No oil top ups were permitted. The amount of additive in the lubricant, at the start and accumulated by the end of test, was measured by GC for the POA5 and Priolube 3970 or LC-MS (liquid chromatography-mass spectrometry) for FM10.

TABLE 5

| | | | Increase in | | | Increase in |
|---|---|---|---|---|---|---|
| | | | Concentration | | | Concentration |
| | Friction | Concentration | in lubricant | Viscosity | Concentration | in lubricant |
| Test | modifier | in fuel | after test | control additive | in fuel | after test |
| 1 | FM10 | 225 ppmw | 2000 ppmw | Synfluid POA5 | 1000 ppmw | 4.5% m/m |
| 2 | FM10 | 225 ppmw | 2100 ppmw | Priolube3970 | 1000 ppmw | 5.1% m/m |

Examples 3 and 4 confirm that both friction modifiers and VCA chemistry can be transferred from the fuel to the lubricant, and, from Example 3, provide fuel economy benefits.

### Example 5

The fuel consumption and fuel economy benefit of various additives dosed directly into the lubricant in the engine sump to mimic the accumulation of additives and additive combinations, as shown to occur in Example 4, was compared with that of an undosed lubricant by using a bench engine test. The test used a Ford Zetec 1.988 litre 4-cylinder inline DOHC petrol engine. The fuel used was an EN228 Low Sulphur E5 Gasoline. The lubricant used was Shell Helix 5W-30 or Shell Helix Plus 10W40.

The engine was clean and free from abnormal levels of Inlet Valve Deposits (IVDs) and Combustion Chamber Deposits (CCDs). The test was based on the continuous repetition of the set of speed/load points (test cycle). The cycle was repeated over a total period of approximately 21 hours (16 hours overnight lubricant de-greening and 5 hours fuel consumption measurements) with scheduled breaks for the acquisition of lubricant samples and the injection of the additive into the crankcase. The percentage change in the brake specific fuel consumption (BSFC) measurement between pre and post sump dosing are shown in the Table below with the data expressed as an average of the test conditions for ease of comparison.

TABLE 6

| | Test | Concentration | Average BSFC |
|---|---|---|---|
| A | NULL | | −0.03% |
| B | CH-5 | 1% v | 0.86% |
| C | CH-5 | 2% v | 1.36% |
| D | CH-5 | 4% v | 1.24% |
| E | CH-2C | 2% v | 0.27% |
| F | CH-6 | 2% v | 0.15% |
| G | Ethomeen T12e | 2% v | 1.19% |
| H | Keracom 3561 | 2% v | 1.36% |
| I | FM10 | 2% v | 1.23% |
| J | Synfluid PAO-5 | 2% v | 0.34% |
| K | Ethomeen T12e | 2% v | 1.36% |
| L | PAO2 (Durasyn 162) | 10% v | 0.48% |
| M | Ethomeen T12e + PAO2 | Ethomeen T12e | 2.17% |
| | (Durasyn 162) | (2% v) + PAO2 | |
| | | (10% v) | |
| N | Ethomeen T12e | 2% v | 1.57% |
| O | Ethomeen O15 | 2% v | 1.24% |
| P | FM10 + Synfluid PAO5 | FM10 (2% v) + | 1.29% |
| | | PAO5 (10% v) | |
| Q | FM10 + Priolube 3970 | FM10 (2% v) + | 1.31% |
| | | Priolube | |
| | | 3970 (10% v) | |
| R | Ethomeen O15 + | Ethomeen O15 | 1.26% |
| | Synfluid PAO5 | (2% v) + PAO5 | |
| | | (10% v) | |

This example confirms that both friction modifiers and VCA chemistry can cause an increase in % benefit fuel consumption when present in the lubricant. A combination of both friction modifiers and VCA components show an increase in % benefit in fuel consumption over and above an additive increase.

The combined results of Examples 3 and 5 show the benefit of using both friction modifiers and VCA in fuel additive formulations to improve fuel consumption, i.e. to improve fuel economy.

1. (canceled)

2. The method of claim 20 wherein the one or more friction modifiers is selected from the group consisting of esters or nitrogen derivatives of alkoxyamines; poly(hydroxycarboxylic) acid amide salt derivatives; poly(hydroxycarboxylic acid) derivatives having a terminal acid group; poly(hydroxycarboxylic acid) derivatives; polyetheramines; esters or nitrogen derivatives of hydroxy polycarboxylic acids; nitrogen derivatives of carboxylic acids; ester derivatives of carboxylic acids; esters of alkylsuccinic acids; alkoxylated alcohols; alkoxylated amines; alkoxylated amides or esters; and mixtures thereof.

3. The method of claim 2 wherein the one or more friction modifiers is selected from the group consisting of poly(hydroxycarboxylic) acid amide salt derivatives; poly(hydroxycarboxylic acid) derivatives having a terminal acid group; poly(hydroxycarboxylic acid) derivatives; polyetheramines; ester or nitrogen derivatives of alkoxyamines; alkoxylated amides or esters; alkoxylated amines; and mixtures thereof.

4. The method of claim 20 wherein the amount of the second fuel additive present in the liquid fuel composition is at least 10 ppmw, based on the overall weight of the liquid fuel composition.

5. The method of claim 4 wherein the amount of the second fuel additive present in the liquid fuel composition is at most 2 wt %, based on the overall weight of the liquid fuel composition.

6. The method of claim 20 wherein the ester has a NOACK volatility at 250° C. of 20% wt or less.

7. The method of claim 20 wherein the ester has a NOACK volatility at 250° C. of 15% wt or less.

8. The method of claim 20 wherein the ester has a NOACK volatility at 250° C. of 10% wt or less.

9. The method of claim 20 wherein the ester has a NOACK volatility at 250° C. of 6% wt or less.

10. The method of claim 20 wherein the ester has a kinematic viscosity at 100° C. of 17 cSt or less.

11. The method of claim 20 wherein the ester has a kinematic viscosity at 100° C. in the range of from 2 cSt to 8 cSt.

12. The method of claim 20 wherein the ester has a kinematic viscosity at 100° C. in the range of from 3 cSt to 8 cSt.

13. The method of claim 20 wherein the ester has a kinematic viscosity at 100° C. in the range of from 4 cSt to 6 cSt.

14-16. (canceled)

17. The method of claim 20 wherein the ester is a trimethyl propane ester.

18. The method of claim 20 wherein the amount of first fuel additive present in the liquid fuel composition is in the range of from 5 ppmw to 2% wt, based on weight of the liquid fuel composition.

19. The method of claim 20 wherein the base fuel is a gasoline.

20. A method of improving the fuel economy performance of an internal combustion engine, said method comprising
(A) fuelling the internal combustion engine containing a lubricant with a liquid fuel composition comprising
(I) a base fuel suitable for use in an internal combustion engine;
(II) an ester selected from one or more viscosity control agents having: (a) kinematic viscosity at 100° C. of 27 cSt or less; and (b) a NOACK volatility at 250° C. of 100% wt or less; and
(III) a second fuel additive selected from one or more friction modifiers, and
(B) operating said fuelled-internal combustion engine.
